(19) United States
(12) Patent Application Publication
(10) Pub. No.: US 2026/0234306 A1
(43) Pub. Date: Aug. 13, 2026

(54) ACTIVE ENERGY RAY-CURABLE COMPOSITION AND CURED PRODUCT THEREOF

(71) Applicants: SANYO CHEMICAL INDUSTRIES, LTD., Kyoto (JP); TODA KOGYO CORP., Hiroshima (JP)

(72) Inventors: Kazuya MAEDA, Kyoto (JP); Toshiki KOJIMA, Kyoto (JP); Naho KAWAI, Hiroshima (JP); Takamoto KAWAGUCHI, Hiroshima (JP); Kousaku TAMARI, Hiroshima (JP); Kenichi NAKATA, Hiroshima (JP)

(73) Assignees: SANYO CHEMICAL INDUSTRIES, LTD., Kyoto (JP); TODA KOGYO CORP., Hiroshima (JP)

(21) Appl. No.: 19/471,831

(22) PCT Filed: Apr. 3, 2024
(86) PCT No.: PCT/JP2024/013702

§ 371 Date: Oct. 2, 2025

(30) Foreign Application Priority Data
Apr. 10, 2023 (JP) 2023-063483

(51) Int. Cl. C08F 220/30; C08F 2/50; C08F 226/08; C08K 3/22; C08K 9/06; C08K 9/08

(52) U.S. Cl. CPC C08F 220/305; C08F 2/50; C08F 226/08; C08K 3/22; C08K 9/06; C08K 9/08; C08K 2003/2237; C08K 2201/005

(57) ABSTRACT

Provided is an active energy ray-curable composition containing: a coated particle (A); a photopolymerizable compound (C); and a photopolymerization initiator (D), the coated particle (A) including: an inorganic particle (A0) containing a titanate compound represented by MTiO₃, where M is at least one of Ba or Sr; and a surface treatment agent (B) coating at least a portion of a surface of the inorganic particle (A0), the coated particle (A) having an average particle size of 10 nm to 40 nm, the surface treatment agent (B) being contained in the coated particle (A) in an amount of 5% by weight to 20% by weight based on a weight of the inorganic particle (A0).

### TECHNICAL FIELD

The present invention relates to active energy ray-curable compositions and cured products thereof.

### BACKGROUND ART

In recent years, high refractive index particles have been extensively studied for use as fillers for antireflective materials, lens materials, high-dielectric materials, and the like. In particular, high refractive index particles of several nanometers to several tens of nanometers are highly valued due to their excellent transparency. Conventionally, zirconia particles had been used for UV curable resins, but they have an insufficient refractive index. Thus, barium titanate particles, which have a higher refractive index (Patent Literatures 1 and 2), have come to be used instead. Non-surface-treated nanoparticles of these, however, exhibit poor dispersibility in a dispersion composition and have insufficient transparency (Patent Literatures 1 and 2). Even when the particles are surface-treated, they exhibit insufficient dispersibility in a dispersion composition and have insufficient transparency (Patent Literature 2).

### CITATION LIST

### Patent Literature

Patent Literature 1: WO 2015/019757
Patent Literature 2: WO 2015/098449

### SUMMARY OF INVENTION

### Technical Problem

The present invention aims to provide an active energy ray-curable composition capable of providing a cured product excellent in transparency, light resistance, and transferability and having a high refractive index.

### Solution to Problem

The present inventors have conducted studies to achieve the above aim, and as a result, have completed the present invention.

Specifically, the present invention relates to an active energy ray-curable composition containing: a coated particle (A); a photopolymerizable compound (C); and a photopolymerization initiator (D), the coated particle (A) including: an inorganic particle (A0) containing a titanate compound represented by MTiO₃, where M is at least one of Ba or Sr; and a surface treatment agent (B) coating at least a portion of a surface of the inorganic particle (A0), the coated particle (A) having an average particle size of 10 nm to 40 nm, the surface treatment agent (B) being contained in the coated particle (A) in an amount of 5% by weight to 20% by weight based on a weight of the inorganic particle (A0). The present invention also relates to a cured product of the active energy ray-curable composition.

### Advantageous Effects of Invention

The present invention can provide an active energy ray-curable composition capable of providing a cured product excellent in transparency, light resistance, and transferability and having a high refractive index.

### DESCRIPTION OF EMBODIMENTS

### <Active Energy Ray-Curable Composition>

The active energy ray-curable composition of the present invention (hereinafter also referred to as “curable composition of the present invention”) is an active energy ray-curable composition containing: a coated particle (A); a photopolymerizable compound (C); and a photopolymerization initiator (D), the coated particle (A) including: an inorganic particle (A0) containing a titanate compound represented by MTiO₃, where M is at least one of Ba or Sr; and a surface treatment agent (B) coating at least a portion of a surface of the inorganic particle (A0), the coated particle (A) having an average particle size of 10 nm to 40 nm, the surface treatment agent (B) being contained in the coated particle (A) in an amount of 5% by weight to 20% by weight based on a weight of the inorganic particle (A0).

### <Coated Particle (A)>

The coated particle (A) is described below.

The coated particle (A) includes an inorganic particle (A0) and a surface treatment agent (B) coating at least a portion of the surface of the inorganic particle (A0).

The inorganic particle (A0) contains a titanate compound represented by MTiO₃ (M is at least one of Ba or Sr). M in MTiO₃ may contain both Ba and Sr, and in that case, MTiO₃ can be represented by (BaₓSr₁₋ₓ)TiO₃ (x is a number greater than 0 and less than 1). The inorganic particle (A0) includes at least one selected from the group consisting of barium titanate [BaTiO₃], strontium titanate [SrTiO₃], and barium strontium titanate [(BaₓSr₁₋ₓ)TiO₃, x is a number greater than 0 and less than 1].

These compounds are generally known to be highly dielectric substances. In the present invention, attention has been focused on the fact that these substances have transparency, have a high refractive index, and do not have the photocatalytic activity exhibited by titanium oxide, and these substances have been investigated for use as novel optical fillers with high transmittance and high refractive index.

Of these titanate compounds, strontium titanate [SrTiO₃] is preferred from the viewpoint of the refractive index of the particle.

The titanate compound represented by MTiO₃ (M is at least one of Ba or Sr) may be a commercially available product.

Alternatively, the titanate compound may be prepared by a known method including a wet reaction between barium hydroxide or strontium hydroxide and titanium tetrachloride, for example.

The composition ratio of M and Ti in MTiO₃ (M is at least one of Ba or Sr) can be determined using an X-ray fluorescence analyzer.

From the viewpoints of light transmittance and refractive index, the inorganic particle (A0) preferably has an average particle size of 10 nm to 40 nm, particularly preferably 10 nm to 30 nm.

In the present invention, the average particle size of the inorganic particle (A0) refers to the average primary particle size determined from about 300 particles in an image (25,000×) obtained using a transmission electron microscope [JEM-F200 available from JEOL Ltd.]. The average primary particle size herein refers to the particle size determined as follows: the areas of the respective particles in the image are measured; circles with the same areas as the respective particles are defined; the diameters of the circles are regarded as the particle sizes of the particles; and the particle sizes are averaged.

The average particle size of the coated particle (A) is 10 to 40 nm, and from the viewpoints of light transmittance and refractive index, it is preferably 10 to 30 nm.

In the present invention, the average particle size of the coated particle (A) is measured by a dynamic light scattering method.

From the viewpoint of excellent control of dispersibility, a wet-synthesized coated particle (A) is a preferred example.

### <Surface Treatment Agent (B)>

The surface treatment agent (B) is described below.

The surface treatment agent (B) coats at least a portion of the surface of the inorganic particle (A0). In the present invention, the term “coat” means a state in which the surface treatment agent (B) is chemically bonded or physically attached to the inorganic particle (A0).

When the surface of the inorganic particle (A0) is coated with the surface treatment agent (B), the coated particle (A) can be dispersed in the curable composition without agglomeration, and a cured product with transparency can be obtained.

The surface treatment agent (B) is preferably a coupling agent (B1) and/or a surfactant (B2), and may be a known agent. The coupling agent (B1) is preferably at least one selected from the group consisting of a silane coupling agent, a titanate coupling agent, and an aluminate coupling agent, and the surfactant (B2) is preferably a surfactant having a hydroxy group, an ester group, a phosphate group, a carboxy group, or an amino group.

Each of the surface treatment agents (B) may be used alone or two or more of these may be used in combination.

### <Coupling Agent (B1)>

The silane coupling agent may be a compound represented by the following formula (1):

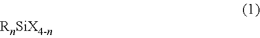

wherein R represents a non-reactive functional group or a group containing a reactive functional group; X represents a hydrolyzable group or a hydroxy group; and n is an integer of 0 to 3, where when n is 2 or more, Rs may be the same as or different from each other, and when (4-n) is 2 or more, Xs may be the same as or different from each other.

Examples of the non-reactive functional group include hydrocarbon groups such as a methyl group, an ethyl group, a butyl group, an isobutyl group, a hexyl group, an octyl group, a decyl group, a phenyl group, a fluorene group, a 3,3,3-trifluoropropyl group, and a perfluorooctyl group, and halogenated hydrocarbon groups.

Examples of the reactive functional group include an amino group, a vinyl group, an epoxy group, a (meth)acryloyloxy group, and a mercapto group. Examples of the group containing a reactive functional group include an N-2-(aminoethyl)-3-aminopropyl group, a vinyl group, a β-(3,4-epoxycyclohexyl)ethyl group, a γ-glycidoxymethyl group, a γ-glycidoxyethyl group, a γ-glycidoxypropyl group, a γ-(β-glycidoxyethoxy)propyl group, a γ-(meth)acryloyloxymethyl group, a γ-(meth)acryloyloxyethyl group, a γ-(meth)acryloyloxypropyl group, and a γ-mercaptopropyl group.

The term “(meth)acryloyloxy” means “acryloyloxy and/or methacryloyloxy”.

Examples of the hydrolyzable group include a chlorine atom and alkoxy groups (e.g., a methoxy group, an ethoxy group, and a propoxy group).

Specific examples of so-called non-reactive silane coupling agents having a non-reactive functional group include methyltrimethoxysilane, dimethyldimethoxysilane, phenyltrimethoxysilane, diphenyldimethoxysilane, methyltriethoxysilane, dimethyldiethoxysilane, phenyltriethoxysilane, diphenyldiethoxysilane, isobutyltrimethoxysilane, butyltrimethoxysilane, hexyltrimethoxysilane, decyltrimethoxysilane, butyltriethoxysilane, isobutyltriethoxysilane, hexyltriethoxysilane, octyltriethoxysilane, decyltriethoxysilane, 3,3,3-trifluoropropyltrimethoxysilane, methyl-3,3,3-trifluoropropyldimethoxysilane, perfluorooctylethyltrimethoxysilane, perfluorooctylethyltriethoxysilane, perfluorooctylethyltriisopropoxysilane, trifluoropropyltrimethoxysilane, methyltrichlorosilane, dimethylmethoxyhydroxysilane, 9H-fluorene-9,9-diylbis[(4,1-phenylene)oxy(3,1-propanediyl)thio(3,1-propanediyl)]bis(trimethoxysilane), bis[3-[3-(trimethoxysilyl)propylsulfanyl]propyl]phthalate, and bis[3-[3-(trimethoxysilyl)propylsulfanyl]propyl]hexahydrophthalate.

Specific examples of so-called reactive silane coupling agents having a group containing a reactive functional group include N-2-(aminoethyl)-3-aminopropyltrimethoxysilane, vinyltrimethoxysilane, vinyltriethoxysilane, vinyltris(β-methoxyethoxy) silane, β-(3,4-epoxycyclohexyl)ethyltrimethoxysilane, γ-glycidoxymethyltrimethoxysilane, γ-glycidoxymethyltriethoxysilane, γ-glycidoxyethyltrimethoxysilane, γ-glycidoxyethyltriethoxysilane, γ-glycidoxypropyltrimethoxysilane, γ-glycidoxypropyltriethoxysilane, γ-(β-glycidoxyethoxy)propyltrimethoxysilane, γ-(meth)acryloyloxymethyltrimethoxysilane, γ-(meth)acryloyloxymethyltriethoxysilane, γ-(meth)acryloyloxyethyltrimethoxysilane, γ-(meth)acryloyloxyethyltriethoxysilane, γ-(meth)acryloyloxypropyltrimethoxysilane (3-(meth)acryloyloxypropyltrimethoxysilane), γ-(meth)acryloyloxypropyltriethoxysilane, and γ-mercaptopropyltrimethoxysilane.

Examples of the titanate coupling agent include isopropyl triisostearoyl titanate, isopropyl tris(dioctyl pyrophosphate) titanate, bis(dioctyl pyrophosphate)oxyacetate titanate, isopropyl tri (N-aminoethyl aminoethyl) titanate, tris(dioctyl pyrophosphate)ethylene titanate, isopropyl dioctyl pyrophosphate titanate, isopropyl tris(dodecylbenzenesulfonyl) titanate, titanium tetra normal butoxide, titanium tetra-2-ethylhexoxide, tetraisopropyl bis(dioctyl phosphite) titanate, tetraoctyl bis(ditridecyl phosphite) titanate, tetra(2,2-diallyloxymethyl-1-butyl)bis(ditridecyl)phosphite titanate, tetraoctyl bis(ditridecyl phosphate) titanate, tetra(2-2-diallyloxymethyl-1-butyl)bis(ditridecyl) phosphate titanate, bis(dioctyl pyrophosphate)oxyacetate titanate, and bis(dioctyl pyrophosphate)ethylene titanate.

Examples of the aluminate coupling agent include acetoalkoxyaluminum diisopropylate, aluminum diisopropoxymonoethylacetoacetate, aluminum trisethylacetoacetate, and aluminum trisacetylacetonate.

Of these coupling agents, from the viewpoint of compatibility with the photopolymerizable compound (C), the silane coupling agents are preferred, and a silane coupling agent having a functional group easily reactive with a matrix for forming a coating (cured product) is more preferred. When the matrix is an acrylic resin, a silane coupling agent that is a compound represented by the formula (1) in which R contains a (meth)acryloyloxy group is preferred, and γ-methacryloyloxypropyltrimethoxysilane and γ-acryloyloxypropyltrimethoxysilane are particularly preferred.

Of these coupling agents, from the viewpoints of refractive index and dispersibility, preferred are 9H-fluorene-9,9-diylbis[(4,1-phenylene)oxy(3,1-propanediyl)thio(3,1-propanediyl)]bis(trimethoxysilane), bis[3-[3-(trimethoxysilyl)propylsulfanyl]propyl] phthalate, bis[3-[3-(trimethoxysilyl)propylsulfanyl]propyl] hexahydrophthalate, and N-phenyl-3-aminopropyltrimethoxysilane. The coupling agent may also be a commercially available product such as OGSOL SC-001 or OGSOL SC-003 (both available from Osaka Gas Chemicals Co., Ltd.).

The coupling agent (B1) preferably has a solubility parameter (hereinafter also referred to as SP value) of 7.0 (cal/cm³)^{1/2} to 9.3 (cal/cm³)^{1/2}, more preferably 7.5 (cal/cm³)^{1/2} to 9.2 (cal/cm³)^{1/2}, particularly preferably 7.9 (cal/cm³)^{1/2} to 9.2 (cal/cm³)^{1/2}, from the viewpoint of dispersibility.

In addition, when the coupling agent (B1) is a mixture of two or more coupling agents, the SP value of the coupling agent (B1) is a weighted average of the SP values of the respective coupling agents based on the weight proportion of each coupling agent.

The solubility parameter in the present invention is calculated by the method described in Polymer Engineering and Science, Vol. 14, pp. 147-154 (1974), by Robert F. Fedors et al. Specifically, the solubility parameter is calculated by the formula (28) on page 153 of the document using the values (heat of vaporization and molar volume at 25° C. of atoms or functional groups) on page 152 (Table. 5). More specifically, the solubility parameter can be calculated by applying to the following equation the values corresponding to the types of atoms and atomic groups in the molecular structure taken from the values Δeᵢ and Δvᵢ of the parameters of the Fedors method in Table 1 below.

$$SP value = {( Σ Δ {e}_{i} / ΣΔ {v}_{i} )}^{1 / 2}$$

In the formula, ΣAeᵢ (unit: cal/mol) is the cohesive energy density (unit: cal/mol), and ΣAvᵢ is the molar volume (unit: cm³/mol).

TABLE 1

| | [symbol] | [symbol] |
|---|---|---|
| Atom or group | cal/mole | cm [symbol] /mole |
| CH [symbol] | 1125 | 33.5 |
| CH [symbol] | 1180 | 16.1 |
| CH | 820 | −1.0 |
| C | 350 | −19.2 |
| H [symbol] | 1030 | 28.5 |
| [symbol] CH [symbol] | 1030 | 13.5 |
| C [symbol] | 1030 | −5.5 |
| HC [symbol] | 920 | 27.4 |
| [symbol] C [symbol] | 1690 | 6.5 |
| Phenyl [symbol] | 7630 | 71.4 |
| Phenylene (o, m, p) [symbol] | 7630 | 52.4 |
| phenyl (trisubstituted) [symbol] | 7630 | 33.4 |
| Phenyl (tetrasubstituted) [symbol] | 7630 | 14.4 |
| Phenyl (pentasubstituted) [symbol] | 7630 | −4.6 |
| Phenyl (hexasubstituted) [symbol] | 7630 | −23.6 |
| Ring closure 5 or more atoms | 250 | 18 |
| Ring closure 3 or 4 atoms | 750 | 18 |
| Conjugation in ring for each | 400 | −2.2 |
| double bond | | |
| Halogen attached to carbon | −20 percent of | 4.0 |
| atom with double bond | [symbol] of halogen | |
| CO [symbol] (carbonate) | 4200 | 22.0 |
| COOH | 6600 | 28.5 |
| CO [symbol] | 4300 | 18.0 |
| CO | 4150 | 10.8 |
| CHO (aldehyde) | 5100 | 22.3 |
| CO₃CO [symbol] (oxalate) | 6400 | 37.3 |
| C [symbol] O [symbol] (anhydride) | 7300 | 30.0 |
| HCOO (formate) | 4300 | 32.5 |
| CONH₃ | 10000 | 17.5 |
| CONH | 8000 | 9.5 |
| CON | 7050 | −7.7 |
| HCON | 6600 | 11.3 |
| HCONH | 10500 | 27.0 |
| COCl | 5000 | 38.0 |
| NH₃ | 3000 | 19.2 |
| NH | 2000 | 4.5 |
| N | 1000 | −9.0 |
| [symbol] N [symbol] | 2800 | 5.0 |
| CN | 6100 | 24.0 |
| NO [symbol] (aliphatic) | 7000 | 24.0 |
| NO [symbol] (aromatic) | 3670 | 32.0 |
| NO [symbol] | 5000 | 33.5 |
| NO [symbol] (nitrite) | 2800 | 33.5 |
| SCN | 4800 | 37.0 |
| NCO | 6800 | 35.0 |
| NF₃ | 1830 | 33.1 |
| NF | 1210 | 24.5 |
| O | 800 | 3.8 |
| OH | 7120 | 10.0 |
| OH (disubstituted or on | 5220 | 13.0 |
| adjacent C atoms) | | |
| PO₄ | 5000 | 28.0 |
| PO₃ | 3400 | 22.7 |
| SH | 3450 | 28.0 |
| S | 3360 | 12 |
| S [symbol] | 5700 | 23.0 |
| SO₃ | 4500 | 27.6 |
| SO₄ | 6800 | 31.6 |
| F | 1000 | 18.0 |
| F (disubstituted) | 850 | 20.0 |
| F (trisubstituted) | 550 | 22.0 |
| CF₃ (for perfluoro | 1020 | 23.0 |
| compounds | | |
| CF [symbol] (for perfluoro | 1020 | 57.5 |
| compounds) | | |
| Cl | 2760 | 24.0 |
| Cl (disubstituted) | 2300 | 26.0 |
| Cl (trisubstituted) | 1800 | 27.3 |
| Br | 3700 | 30.0 |
| Br (disubstituted) | 2950 | 31.0 |
| Br (trisubstituted) | 2550 | 32.4 |
| I | 4550 | 31.5 |
| I (disubstituted) | 4000 | 33.3 |
| I (trisubstituted) | 3900 | 37.0 |
| B | 3300 | −2.0 |
| Al | 3300 | −2.0 |
| Ga | 3300 | −2.0 |
| In | 3300 | −2.0 |
| Tl | 3300 | −2.0 |
| Si | 810 | 0 |
| Ge | 1930 | −1.5 |
| Sn | 2700 | 1.5 |
| Pb | 4100 | 2.5 |
| P | 2250 | −1.0 |
| As | 3100 | 7.0 |
| Sb | 3900 | 8.9 |
| Bi | 5100 | 9.5 |
| Se | 4100 | 16.0 |
| Te | 4800 | 17.4 |
| Zn | 3460 | 2.5 |
| Cd | 4250 | 6.5 |
| Hg | 5450 | 7.6 |

[symbol]

indicates data missing or illegible when filed

### <Surfactant (B2)>

From the viewpoint of particle dispersibility, the surfactant (B2) preferably has a hydroxy group, an ester group, a phosphate group (or a phosphate ester group), a carboxy group, or an amino group, which have high affinity with the particle surface.

Examples of a surfactant having a hydroxy group include IONET S-80 (Sanyo Chemical Industries, Ltd.) and EMANON 1112 (Kao Corporation).

Examples of a surfactant having an ester group include Sanflex EB-200 and Sanflex EB-300 (both available from Sanyo Chemical Industries, Ltd.).

Examples of a surfactant having a phosphate group or a phosphate ester group include alkyl ether phosphate esters. Examples of the alkyl ether phosphate esters include IONET 1310R [Sanyo Chemical Industries, Ltd.], NEWCOL 1000-FCP [Nippon Nyukazai Co., Ltd.], ANTOX EHD-400 [Nippon Nyukazai Co., Ltd.], TEGO® Dispers 651 and Dispers 655 [Evonik], Plysurf series [DKS Co. Ltd.], HIPLAAD®, and ED-153 [Kusumoto Chemicals, Ltd.]. Examples of a surfactant having a phosphate group other than the alkyl ether phosphate esters include Light Acrylate P-1A [Kyoeisha Chemical Co., Ltd.], Light Ester P-1M [Kyoeisha Chemical Co., Ltd.], TEGO® Dispers 656 [Evonik], and KAYAMER PM-2 and KAYAMER PM-21 [both available from Nippon Kayaku Co., Ltd.].

Examples of a surfactant having a carboxy group include alkyl ether carboxylic acids. Examples of the alkyl ether carboxylic acids include BEAULIGHT LCA-H and BEAULIGHT LCA-25NH [both available from Sanyo Chemical Industries, Ltd.]. Examples of a surfactant having a carboxy group other than the alkyl ether carboxylic acids include TEGO® Dispers 652 and Dispers 690 [both available from Evonik] and Disparlon 2150 [Kusumoto Chemicals, Ltd.].

Examples of a surfactant having an amino group include Disparlon DA-234 [Kusumoto Chemicals, Ltd.] and Solsperse 32000 [Lubrizol].

Among the surfactants (B2), those containing an acidic group such as a phosphate group (or a phosphate ester group) or a carboxy group are more preferred from the viewpoint of dispersibility, and an alkyl ether phosphate ester or an alkyl ether carboxylic acid is particularly preferred. This is because an acidic group can be chemically bonded to the inorganic particle, or an acidic group in the form of carboxylic acid, phosphoric acid, or a salt can be attached to the inorganic particle.

The amount of the surface treatment agent (B) in the coated particle (A) is 5% by weight to 20% by weight based on the weight of the inorganic particle (A0), and from the viewpoint of dispersibility, the amount is preferably 10% by weight to 20% by weight. The amount of the surface treatment agent can also be calculated using a thermogravimetric differential thermal analyzer (TG-DTA).

When the surface treatment agent (B) includes two or more compounds, the amount of the surface treatment agent (B) refers to the total amount of these compounds.

The inorganic particle (A0) can be coated with the surface treatment agent (B) by, for example, a method in which the inorganic particle (A0) is dispersed in a solvent with a predetermined temperature, then a predetermined amount of the surface treatment agent (B) is added to the solvent, and they are mixed for a predetermined time. Here, the dispersibility of the powder is preferably increased using a bead mill immediately before addition of the surface treatment agent (B).

### <Photopolymerizable Compound (C)>

The photopolymerizable compound (C) is described below.

The photopolymerizable compound (C) is not limited as long as it is a compound curable by active energy rays. Specific examples include a (meth)acrylate (C1), a (meth)acrylamide (C2), and a N-vinyl compound (C3).

Each of the photopolymerizable compounds (C) may be used alone or two or more of these may be used in combination.

The “(meth)acrylate” refers to “acrylate and/or methacrylate”. The “(meth)acrylic” refers to “acrylic and/or methacrylic”.

Examples of the (meth)acrylate (C1) include a monofunctional (meth)acrylate having one (meth)acrylate group in the molecule, a monofunctional urethane (meth)acrylate having one (meth)acrylate group in the molecule, a polyfunctional (meth)acrylate compound having two or more (meth)acrylate groups in the molecule, and a polyfunctional urethane (meth)acrylate having two or more (meth)acrylate groups in the molecule.

Examples of the monofunctional (meth)acrylate include mono(meth)acrylate compounds such as n-butyl(meth)acrylate, isobutyl(meth)acrylate, tert-butyl (meth)acrylate, n-pentyl(meth)acrylate, n-hexyl(meth)acrylate, n-octyl(meth)acrylate, isooctyl(meth)acrylate, 2-ethylhexyl(meth)acrylate, glycidyl(meth)acrylate, morpholine (meth)acrylate, 2-hydroxyethyl(meth)acrylate, 2-hydroxypropyl(meth)acrylate, 4-hydroxybutyl(meth)acrylate, 2-methoxyethyl(meth)acrylate, 2-butoxyethyl(meth)acrylate, 2-ethoxyethyl(meth)acrylate, 2-(2-ethoxyethoxy)ethyl(meth)acrylate, 4-nonylphenoxyethylene glycol (meth)acrylate, tetrahydrofurfuryl(meth)acrylate, caprolactone-modified tetrahydrofurfuryl(meth)acrylate, cyclohexyl(meth)acrylate, cyclohexylmethyl(meth)acrylate, cyclohexylethyl(meth)acrylate, isobornyl(meth)acrylate, dicyclopentanyl(meth)acrylate, dicyclopentanyloxyethyl(meth)acrylate, dicyclopentenyl(meth)acrylate, dicyclopentenyloxyethyl(meth)acrylate, phenyl(meth)acrylate, benzyl(meth)acrylate, phenoxyethyl(meth)acrylate, phenoxy 2-methylethyl(meth)acrylate, phenoxyethoxyethyl (meth)acrylate (phenoxy diethylene glycol (meth)acrylate), para-cumylphenoxyethyl(meth)acrylate, phenoxybenzyl(meth)acrylate, 2-hydroxy-3-phenoxypropyl(meth)acrylate, phenylbenzyl(meth)acrylate, phenylphenoxyethyl acrylate (o-phenoxyphenylethyl acrylate), 2-acryloyloxyethyl hexahydrophthalate, and a fluorene backbone-containing mono(meth)acrylate compound.

Examples of the monofunctional urethane (meth)acrylate include a reaction product of a hydroxy group-containing monofunctional (meth)acrylate (a) and an organic monoisocyanate compound (b).

Examples of the hydroxy group-containing monofunctional (meth)acrylate (a) include hydroxyalkyl (meth)acrylates such as 2-hydroxyethyl(meth)acrylate, 2-hydroxypropyl(meth)acrylate, 3-hydroxypropyl(meth)acrylate, 2-hydroxybutyl(meth)acrylate, 4-hydroxybutyl(meth)acrylate, and 1,4-cyclohexanedimethanol monoacrylate.

Each of the hydroxy group-containing monofunctional (meth)acrylates (a) may be used alone or two or more of these may be used in combination.

Examples of the organic monoisocyanate compound (b) include an aliphatic monoisocyanate compound (b1), an alicyclic monoisocyanate compound (b2), and an aromatic monoisocyanate compound (b3).

Examples of the aliphatic monoisocyanate compound (b1) include methyl isocyanate, ethyl isocyanate, propyl isocyanate, isopropyl isocyanate, butyl isocyanate, hexyl acrylate, octyl isocyanate, lauryl isocyanate, tetradecyl isocyanate, hexadecyl isocyanate, and octadecyl isocyanate.

Examples of the alicyclic monoisocyanate compound (b2) include cyclohexyl isocyanate.

Examples of the aromatic monoisocyanate compound (b3) include phenyl isocyanate and tolylene isocyanate.

Each of the organic monoisocyanate compounds (b) may be used alone or two or more of these may be used in combination.

The monofunctional urethane (meth)acrylate can be obtained by subjecting a hydroxy group-containing monofunctional (meth)acrylate (a) and an organic monoisocyanate compound (b) to a urethanization reaction by a known method. The monofunctional urethane (meth)acrylate may also be a commercially available product such as Viscoat #216 [Osaka Organic Chemical Industry Ltd.], Etermer EM2080 [Eternal Materials Co., Ltd.], and Genomer 1122 [Rahn AG].

Examples of the polyfunctional (meth)acrylate compound include a difunctional (meth)acrylate, a trifunctional (meth)acrylate, a tetrafunctional (meth)acrylate, a pentafunctional (meth)acrylate, and a (meth)acrylate having six or more functional groups.

Examples of the difunctional (meth)acrylate include a di(meth)acrylate of an adduct of a dihydric phenol compound [monocyclic phenols (e.g., catechol, resorcinol, and hydroquinone), condensed polycyclic phenols (e.g., dihydroxynaphthalene), bisphenol compounds (e.g., bisphenol A, bisphenol F, and bisphenol S)] with an alkylene oxide (hereinafter, the alkylene oxide may be abbreviated as “AO”) (e.g., ethoxylated bisphenol A diacrylate); acrylic modified bisphenoxyethanol fluorene; polyalkylene glycol di(meth)acrylates (e.g., polypropylene glycol diacrylates such as dipropylene glycol diacrylate); dimethylol-tricyclodecane di(meth)acrylate; 1,4-butanediol di(meth)acrylate; and 1,9-nonanediol di(meth)acrylate.

Specific examples of the di(meth)acrylate of an adduct of a dihydric phenol compound with AO include a di(meth)acrylate of an adduct of resorcinol with 4 mol ethylene oxide (hereinafter, the ethylene oxide may be abbreviated as “EO”), a di(meth)acrylate of an adduct of dihydroxynaphthalene with 4 mol propylene oxide (hereinafter, the propylene oxide may be abbreviated as “PO”), a di(meth)acrylate of an adduct of bisphenol A with 4 mol EO, a di(meth)acrylate of an adduct of bisphenol A with 10 mol EO, and a di(meth)acrylate of an adduct of bisphenol A with 20 mol EO.

Examples of the trifunctional (meth)acrylate include trimethylolpropane tri (meth)acrylate, a tri (meth)acrylate of an adduct of trimethylolpropane with AO [e.g., an adduct of trimethylolpropane with 6 mol EO, 9 mol EO, 15 mol EO, 20 mol EO, or 9 mol PO], pentaerythritol tri (meth)acrylate, a tri (meth)acrylate of an adduct of pentaerythritol with AO [e.g., an adduct of pentaerythritol with 6 mol EO], and a tri (meth)acrylate of an adduct of glycerol with AO [e.g., an adduct of glycerol with 6 mol EO or 3 mol PO].

Examples of the tetrafunctional (meth)acrylate include pentaerythritol tetra(meth)acrylate, a tetra(meth)acrylate of an adduct of pentaerythritol with AO [e.g., an adduct of pentaerythritol with 2 mol EO, 4 mol EO, 10 mol EO, 15 mol EO, or 35 mol EO], and a tetra(meth)acrylate of an adduct of ditrimethylolpropane with AO [e.g., an adduct of ditrimethylolpropane with 10 mol EO].

Examples of the pentafunctional (meth)acrylate include dipentaerythritol penta (meth)acrylate and a penta (meth)acrylate of an adduct of dipentaerythritol with AO (e.g., an adduct of dipentaerythritol with 2 mol EO, 4 mol EO, 10 mol EO, or 15 mol EO).

Examples of the (meth)acrylate having six or more functional groups include dipentaerythritol hexa (meth)acrylate, a hexa (meth)acrylate of an adduct of dipentaerythritol with AO [e.g., an adduct of dipentaerythritol with 2 mol EO, 4 mol EO, 10 mol EO, or 15 mol EO], and a hexa (meth)acrylate of an adduct of dipentaerythritol with lactone (e.g., γ-butyrolactone, γ-valerolactone, or &-caprolactone) [e.g., an adduct of dipentaerythritol with 3 mol s-caprolactone, 6 mol &-caprolactone, or 12 mol s-caprolactone].

Examples of the polyfunctional urethane (meth)acrylate compound include a difunctional urethane (meth)acrylate, a trifunctional urethane (meth)acrylate, a tetrafunctional urethane (meth)acrylate, a pentafunctional urethane (meth)acrylate, and a urethane (meth)acrylate having six or more functional groups.

The polyfunctional urethane (meth)acrylate may be a commercially available product. Examples of commercially available products include Ebecryl 230, Ebecryl 8807, Ebecryl 9270, Ebecryl 8800, Ebecryl 4513, Ebecryl 680, Ebecryl 5129, KRM 8296, and KRM 8904 (all available from Daicel-Allnex Ltd.).

Of these (meth)acrylates, from the viewpoints of curability, dispersibility, and refractive index, preferred are phenoxyethyl acrylate, phenoxydiethylene glycol acrylate, o-phenoxyphenylethyl acrylate, m-phenoxybenzyl acrylate, benzyl acrylate, acrylic modified bisphenoxyethanol fluorene, 1,4-butanediol diacrylate, 1,9-nonanediol diacrylate, dipropylene glycol diacrylate, dimethylol-tricyclodecane diacrylate, ethoxylated bisphenol A diacrylate, methoxylated bisphenol A diacrylate, pentaerythritol tetraacrylate, and dipentaerythritol hexaacrylate, and more preferred are phenoxyethyl acrylate, phenoxydiethylene glycol acrylate, o-phenoxyphenylethyl acrylate, m-phenoxybenzyl acrylate, benzyl acrylate, acrylic modified bisphenoxyethanol fluorene, dimethylol-tricyclodecane diacrylate, ethoxylated bisphenol A diacrylate, and methoxylated bisphenol A diacrylate.

Examples of the (meth)acrylamide (C2) include (meth)acrylamide, an N-alkoxy (meth)acrylamide, an N-alkyl(meth)acrylamide, an N-alkoxyalkyl(meth)acrylamide, an N-hydroxyalkyl(meth)acrylamide, an N,N-dialkyl(meth)acrylamide, an N-alkoxy-N-alkyl(meth)acrylamide, and a cyclic amide having an N-(meth)acryloyl group.

Examples of the N-alkoxy (meth)acrylamide include N-methoxy(meth)acrylamide, N-ethoxy(meth)acrylamide, N-propoxy(meth)acrylamide, and N-butoxy (meth)acrylamide.

Examples of the N-alkyl (meth)acrylamide include N-methyl(meth)acrylamide, N-ethyl(meth)acrylamide, N-isopropyl(meth)acrylamide, and N-butyl(meth)acrylamide.

Examples of the N-alkoxyalkyl (meth)acrylamide include N-n-butoxymethylacrylamide.

Examples of the N-hydroxyalkyl (meth)acrylamide include N-hydroxyethyl(meth)acrylamide.

Examples of the N,N-dialkyl (meth)acrylamide include N,N-dimethyl(meth)acrylamide, N,N-diethyl(meth)acrylamide, N,N-dipropyl(meth)acrylamide, N,N-diisopropyl(meth)acrylamide, N,N-dibutyl(meth)acrylamide, N,N-diisobutyl(meth)acrylamide, N,N-di-tert-butyl(meth)acrylamide, N,N-diheptyl(meth)acrylamide, N,N-dioctyl(meth)acrylamide, N,N-di-tert-octyl(meth)acrylamide, N,N-didodecyl(meth)acrylamide, and N,N-dioctadecyl(meth)acrylamide.

Examples of the N-alkoxy-N-alkyl (meth)acrylamide include N-n-butoxy-N-methyl(meth)acrylamide, N-methyl-N-methoxy(meth)acrylamide, N-methyl-N-ethoxy(meth)acrylamide, N-methyl-N-propoxy(meth)acrylamide, N-ethyl-N-methoxy(meth)acrylamide, N-ethyl-N-ethoxy(meth)acrylamide, N-ethyl-N-butoxy (meth)acrylamide, N-propyl-N-methoxy(meth)acrylamide, N-propyl-N-ethoxy(meth)acrylamide, N-butyl-N-methoxy(meth)acrylamide, and N-butyl-N-ethoxy(meth)acrylamide.

Examples of the cyclic amide having an N-(meth)acryloyl group include N-(meth)acryloylmorpholine, N-(meth)acryloylthiomorpholine, N-(meth)acryloylpiperidine, N-(meth)acryloylpyrrolidine, and N-(meth)acryloylpiperidine.

Of these (meth)acrylamides, from the viewpoints of curability, dispersibility, and refractive index, preferred are N-alkoxyalkyl(meth)acrylamide, N-hydroxyalkyl(meth)acrylamide, N,N-dialkyl(meth)acrylamide, N-alkoxy-N-alkyl(meth)acrylamide, and a cyclic amide having an N-(meth)acryloyl group, and more preferred are N,N-dimethylacrylamide, N,N-diethylacrylamide, N-acryloylmorpholine, N-n-butoxymethylacrylamide, and N-hydroxyethylacrylamide.

Examples of the N-vinyl compound (C3) include N-vinyl-2-pyrrolidone, N-vinylcaprolactam, N-vinylimidazole, N-vinylacetamide, N-vinylformamide, 5-methyl-3-vinyl-2-oxazolidinone, N-vinylcarbazole, and N-vinylphthalimide.

Of these, from the viewpoints of curability, dispersibility, and refractive index, preferred are N-vinyl-2-pyrrolidone, N-vinylcaprolactam, N-vinylimidazole, N-vinylacetamide, N-vinylformamide, and 5-methyl-3-vinyl-2-oxazolidinone, and more preferred are N-vinyl-2-pyrrolidone, N-vinylcaprolactam, N-vinylimidazole, and 5-methyl-3-vinyl-2-oxazolidinone.

From the viewpoint of the refractive index of the cured product, the photopolymerizable compound (C) preferably has at least one aromatic ring, more preferably two or more aromatic rings.

The photopolymerizable compound (C) preferably has a refractive index of 1.50 or higher, more preferably 1.55 or higher, particularly preferably 1.60 or higher, from the viewpoint of the refractive index of the cured product. A photopolymerizable compound having a refractive index of lower than 1.50 may also be used as long as the refractive index does not decrease much.

The refractive index of the photopolymerizable compound (C) is measured in an uncured state at 25° C. using the D line in the sodium spectrum, in accordance with JIS-K 0062:1992, with an Abbe refractometer [e.g., DR-M2 available from Atago Co., Ltd.].

When the photopolymerizable compound (C) is a mixture of two or more compounds, the refractive index of the mixture is measured under the above-mentioned conditions.

From the viewpoint of dispersibility, the photopolymerizable compound (C) preferably has an SP value of 7.5 (cal/cm³)^{1/2} to 14.4 (cal/cm³)^{1/2}, more preferably 9.1 (cal/cm³)^{1/2} to 14.4 (cal/cm³)^{1/2}, particularly preferably 9.2 (cal/cm³)^{1/2} to 12.0 (cal/cm³)^{1/2}. When the photopolymerizable compound (C) is a mixture of two or more compounds, the SP value of the photopolymerizable compound (C) is a weighted average of the SP values of the respective photopolymerizable compounds, based on the weight proportion of each photopolymerizable compound, similar to the SP value of the coupling agent (B1).

The absolute value of the difference (ASP value) between the solubility parameter of the photopolymerizable compound (C) and the solubility parameter of the coupling agent (B1) is preferably 0.5 (cal/cm³)^{1/2} to 4.0 (cal/cm³)^{1/2}, more preferably 0.5 (cal/cm³)^{1/2} to 2.0 (cal/cm³)^{1/2}, from the viewpoint of the wettability of the photopolymerizable compound (C) to the particle (A).

The photopolymerizable compound (C) preferably has a viscosity at 25° C. of 1300 mPa·s or less, more preferably 2 to 1300 mPa·s, particularly preferably 2 to 700 mPa·s, from the viewpoint of transferability. The viscosity at 25° C. of the photopolymerizable compound (C) can be adjusted in accordance with the types and composition ratio of the monomers constituting the photopolymerizable compound (C). When the photopolymerizable compound (C) is a mixture of two or more compounds, the viscosity at 25° C. of the mixture is measured.

The viscosity at 25° C. of the photopolymerizable compound (C) can be measured with an E-type viscometer (e.g., “TV-25L type viscometer” available from Toki Sangyo Co., Ltd.) in accordance with JIS Z 8803.

### <Photopolymerization Initiator (D)>

The photopolymerization initiator (D) is described below.

The photopolymerization initiator (D) may be any of a radical photopolymerization initiator, an anionic photopolymerization initiator, and a cationic photopolymerization initiator.

Examples of the photopolymerization initiator (D) include a benzoin compound (D1), an alkylphenone compound (D2), an anthraquinone compound (D3), a thioxanthone compound (D4), a ketal compound (D5), a benzophenone compound (D6), a phosphine oxide (D7), and an oxime ester compound (D8).

Examples of the benzoin compound (D1) include benzoin, benzoin methyl ether, benzoin ethyl ether, benzoin propyl ether, and benzoin isobutyl ether.

Examples of the alkylphenone compound (D2) include acetophenone, 2,2-diethoxy-2-phenylacetophenone, 2,2-diethoxy-2-phenylacetophenone, 1,1-dichloroacetophenone, 2-hydroxy-2-methyl-phenylpropan-1-one, diethoxyacetophenone, 1-hydroxycyclohexyl phenyl ketone, 2-methyl-1-[4-(methylthio)phenyl]-2-morpholinopropan-1-one, and 2-(dimethylamino)-2-[(4-methylphenyl)methyl]-1-[4-(4-morpholinyl)phenyl]-1-butanone.

Examples of the anthraquinone compound (D3) include 2-ethylanthraquinone, 2-t-butylanthraquinone, 2-chloroanthraquinone, and 2-amylanthraquinone.

Examples of the thioxanthone compound (D4) include 2,4-diethylthioxanthone, 2-isopropylthioxanthone, and 2-chlorothioxanthone.

Examples of the ketal compound (D5) include acetophenone dimethyl ketal and benzyl dimethyl ketal.

Examples of the benzophenone compound (D6) include benzophenone, 4-benzoyl-4′-methyldiphenyl sulfide, and 4,4′-bismethylaminobenzophenone.

Examples of the phosphine oxide (D7) include 2,4,6-trimethylbenzoyldiphenylphosphine oxide, bis-(2,6-dimethoxybenzoyl)-2,4,4-trimethylpentylphosphine oxide, and bis(2,4,6-trimethylbenzoyl)-phenylphosphine oxide.

Examples of the oxime ester compound (D8) include 1-[4-(phenylthio)phenyl]-1,2-octanedione 2-(O-benzoyloxime) and ethanone-1-[9-ethyl-6-(2-methylbenzoyl)-9H-carbazol-3-yl]-1-(O-acetyloxime).

Of these photopolymerization initiators (D), 2,4,6-trimethylbenzoyldiphenylphosphine oxide, bis-(2,6-dimethoxybenzoyl)-2,4,4-trimethylpentylphosphine oxide, and bis(2,4,6-trimethylbenzoyl)-phenylphosphine oxide are preferred from the viewpoint of curability.

Each of the photopolymerization initiators (D) may be used alone or two or more of these may be used in combination.

The active energy ray-curable composition of the present invention can be produced by, for example, homogeneously mixing a coated particle (A), a photopolymerizable compound (C), a photopolymerization initiator (D), and an optional different component, using a known mechanical mixing method (a method using a mechanical stirrer, a magnetic stirrer, or the like).

The coated particle (A) may be dispersed in an organic solvent (e.g., ethylene glycol monomethyl ether, acetone, methyl ethyl ketone, methyl isobutyl ketone, or propylene glycol monomethyl ether acetate) for use. In this case, a curable composition containing an organic solvent is obtained. The proportion of each component may be adjusted by distilling off the organic solvent under reduced pressure.

The curable composition may further contain an additional surface treatment agent (B). The additional surface treatment agent (B) is preferably a surfactant (B2).

The total amount of the surface treatment agent (B) contained in the curable composition is preferably 5% by weight to 20% by weight, more preferably 10% by weight to 20% by weight, based on the weight of the inorganic particle (A0). Here, the “total amount of the surface treatment agent (B)” refers to the sum of the amount of the surface treatment agent (B) contained in the coated particle (A) and the amount of the additional surface treatment agent (B) optionally added during preparation of the curable composition.

The amount of the coated particle (A) in the present invention is preferably 49% by weight to 96% by weight, more preferably 69% by weight to 95% by weight, based on the total weight of the inorganic particle (A0), the surface treatment agent (B), the photopolymerizable compound (C), and the photopolymerization initiator (D), from the viewpoints of the refractive index of the cured product and adhesion to a substrate.

The amount of the photopolymerizable compound (C) in the present invention is preferably 3% by weight to 50% by weight, more preferably 4% by weight to 30% by weight, based on the total weight of the inorganic particle (A0), the surface treatment agent (B), the photopolymerizable compound (C), and the photopolymerization initiator (D), from the viewpoints of the refractive index of the cured product and adhesion to a substrate.

The amount of the photopolymerization initiator (D) in the present invention is preferably 0.1% by weight to 10% by weight, more preferably 0.1% by weight to 5% by weight, particularly preferably 0.1% by weight to 3% by weight, based on the total weight of the inorganic particle (A0), the surface treatment agent (B), the photopolymerizable compound (C), and the photopolymerization initiator (D), from the viewpoint of curability.

The curable composition of the present invention may optionally be diluted with a leveling agent (F), as long as the effects of the present invention are not impaired.

Examples of the leveling agent (F) include fluorine additives such as BM-1000 and BM-1100 [both available from BM CHEMIE], Megaface F-142D, F-172, F-173, F-183, F-178, F-471, F-477, F-444, F-552, and F-554 [all available from DIC Corporation], and Surflon S-242, S-420, S-431, S-386, S-611, S-651, S-656, S-658, and S-693 [all available from AGC Seimi Chemical Co., Ltd.]. Examples of an acrylic leveling agent include Disparlon UVX-36 [Kusumoto Chemicals, Ltd.]. Examples of a silicone leveling agent include BYK-333 (BYK Japan KK), KP-423 [Shin-Etsu Chemical Co., Ltd.], and Polyflow KL-401 [Kyoeisha Chemical Co., Ltd.).

Each of the leveling agents (F) may be used alone or two or more of these may be used in combination.

The curable composition of the present invention may optionally be diluted with an organic solvent (G), as long as the effects of the present invention are not impaired.

Examples of the organic solvent (G) include alcohols (e.g., methanol, ethanol, isopropanol, butanol, octanol, 1-methoxy-2-propanol, and 2-methoxyethanol); ketones (e.g., acetone, methyl ethyl ketone, methyl isobutyl ketone, and cyclohexanone); esters (e.g., ethyl acetate, butyl acetate, ethyl lactate, γ-butyrolactone, propylene glycol monomethyl ether acetate (PGMEA: 2-methoxy-1-methylethyl acetate), and propylene glycol monoethyl ether acetate); ethers (e.g., ethylene glycol monomethyl ether and diethylene glycol monobutyl ether); aromatic hydrocarbons (e.g., benzene, toluene, and xylene); amides (e.g., dimethylformamide, dimethylacetamide, and N-methylpyrrolidone).

Of these, from the viewpoint of the compatibility with the active energy ray-curable composition of the present invention, preferred are methanol, isopropanol, butanol, methyl ethyl ketone, methyl isobutyl ketone, ethyl acetate, ethylene glycol monomethyl ether, propylene glycol monomethyl ether, toluene, and xylene.

Each of these organic solvents (G) may be used alone or two or more of these may be used in combination.

In the case where the organic solvent (G) is contained, the amount of the organic solvent (G) is preferably 0.01% by weight to 800% by weight, more preferably 0.1% by weight to 700% by weight, particularly preferably 1% by weight to 500% by weight, based on the total weight of the coated particle (A), the photopolymerizable compound (C), and the photopolymerization initiator (D), from the viewpoints of coatability and reduction of volatile organic compounds (VOCs).

The curable composition of the present invention may further contain additives such as anti-aging agents, antistatic agents, flame retardants, adhesion promoters, dispersants, antioxidants, defoamers, matting agents, light stabilizers, dyes, and pigments, in addition to the above-mentioned components, as long as the aim of the present invention is not impaired.

The amount of each additive is preferably 20% by weight or less, more preferably 10% by weight or less, particularly preferably 5% by weight or less, based on the total weight of the coated particle (A), the photopolymerizable compound (C), and the photopolymerization initiator (D), from the viewpoint of refractive index.

### <Cured Product>

The cured product of the present invention can be obtained by curing the active energy ray-curable composition of the present invention. For example, the cured product is obtainable by applying active energy rays to a coating film obtained by molding the active energy ray-curable composition of the present invention.

Examples of active energy rays include visible light, ultraviolet light, infrared light, X-rays, α-rays, β-rays, γ-rays, and electron beams. Ultraviolet light refers to light having a wavelength of 200 nm to 410 nm.

The wavelength of the active energy rays is not limited as long as it can lead to curing of the composition, and is preferably 350 nm to 410 nm, more preferably 385 nm to 405 nm. A representative example of the active energy rays is light with a wavelength of 395 nm.

The irradiance of the active energy rays is not limited as long as it can lead to curing of the composition, and is preferably 20 mW/cm² to 20000 mW/cm².

The cumulative exposure of the active energy rays is preferably 100 mJ/cm² to 4000 mJ/cm². The application time of the active energy rays may be determined according to the irradiance.

When the active energy rays are ultraviolet rays, the light source may be a lamp such as a high-pressure mercury lamp, an ultra-high-pressure mercury lamp, a metal halide lamp, or a high-power metal halide lamp (RadTech Japan (ed.), The Latest Development Trends in UV/EB Curing Technology, CMC Publishing, p. 138, 2006.), or an LED. In particular, LEDs consume less power and generate less ozone than other light sources, resulting in lower running costs and reduced environmental impact. Curing with an LED light source may be performed using an LED light source UV irradiator [e.g., LED light source UV irradiator “FJ100”, 150×20, 365, available from Phoseon Technology].

Active energy rays may be applied to a certain area or in a linear manner. When active energy rays are applied in a linear manner, the coating film is moved relative to the light source or the light source is moved relative to the coating film, whereby light can be applied to the entire coating film. When active energy rays are applied in a linear manner, the application time of the active energy rays is easily adjusted, allowing the cumulative exposure to be easily adjusted.

The application of active energy rays may be carried out in air. Since the composition of the present invention has good reactivity, the reaction of the composition can proceed even in air, allowing the composition to be cured. In particular, the composition is preferably cured by application of active energy rays in dry air. In this case, moisture absorption by the cured product of the composition can be suppressed.

In the present invention, the cured product may be subsequently heated. Heating can further promote curing and reduce the linear expansion coefficient of the cured product. In the heating, the heating temperature is preferably 90° C. or higher.

The total light transmittance of the cured product of the present invention, when it has a thickness of 1 μm, is preferably 80% or higher. Use of such a cured product for optical components such as a sealant in an organic EL light emitting device can improve particularly the extraction efficiency of light transmitted through the optical components and emitted outside.

The present specification describes the following aspects of the invention.

(1)

An active energy ray-curable composition, containing:
a coated particle (A);
a photopolymerizable compound (C); and
a photopolymerization initiator (D),
the coated particle (A) including:
an inorganic particle (A0) containing a titanate compound represented by MTiO₃, where M is at least one of Ba or Sr; and
a surface treatment agent (B) coating at least a portion of a surface of the inorganic particle (A0),
the coated particle (A) having an average particle size of 10 nm to 40 nm,
the surface treatment agent (B) being contained in the coated particle (A) in an amount of 5% by weight to 20% by weight based on a weight of the inorganic particle (A0).
   (2)

The active energy ray-curable composition according to (1),
wherein the surface treatment agent (B) is at least one of a coupling agent (B1) or a surfactant (B2), the coupling agent (B1) is at least one selected from the group consisting of a silane coupling agent, a titanate coupling agent, and an aluminate coupling agent, and the surfactant (B2) is a surfactant having a hydroxy group, an ester group, a phosphate group, a carboxy group, or an amino group.
   (3)

The active energy ray-curable composition according to (2),
wherein the coupling agent (B1) has a solubility parameter of 7.0 (cal/cm³)^{1/2} to 9.3 (cal/cm³)^{1/2}.
   (4)

The active energy ray-curable composition according to (2) or (3),
wherein an absolute value of a difference between a solubility parameter of the photopolymerizable compound (C) and the solubility parameter of the coupling agent (B1) (ΔSP value) is 0.5 (cal/cm³)^{1/2} to 4.0 (cal/cm³)^{1/2}.
   (5)

The active energy ray-curable composition according to any one of (1) to (4), wherein the photopolymerizable compound (C) has a refractive index of 1.50 or higher.

(6)

The active energy ray-curable composition according to any one of (1) to (5), wherein the photopolymerizable compound (C) has a viscosity at 25° C. of 1300 mPa·s or less.

(7)

A cured product of the active energy ray-curable composition according to any one of (1) to (6).

### EXAMPLES

The present invention is described in more detail below with reference to examples and comparative examples, but the present invention is limited to these examples.

### <Preparation of Coated Particle>

The average particle size of coated particles was measured by a dynamic light scattering method using a particle size analyzer ELSZ-1000 available from Otsuka Electronics Co., Ltd.

### PRODUCTION EXAMPLE 1

An aqueous strontium hydroxide solution and an aqueous titanium tetrachloride solution were mixed at a Sr to Ti molar ratio (Sr/Ti) of 1.32 and subjected to a neutralization reaction. Thereafter, the reaction product was washed with water to obtain a titanium hydroxide slurry. An aqueous strontium hydroxide solution and the titanium hydroxide slurry obtained above were placed in a reaction vessel at a Sr to Ti molar ratio (Sr/Ti) of 2 and subjected to a hydrothermal reaction at 180° C. for eight hours. Thus, a white powder of strontium titanate fine particles (A0-1) was obtained. The fine particles (A0-1) had an average particle size of 18 nm. The Sr/Ti composition ratio measured using an X-ray fluorescence analyzer (Simultix12, available from Rigaku Corporation) was 0.98.

Then, 85 parts by weight of 2-methoxyethanol (G-1) and 15 parts by weight of the fine particles (A0-1) were mixed in a 200 mL wide-mouth jar (mayonnaise jar), and zirconia beads (Nikkato Corporation, diameter 50 μm) were added thereto, followed by dispersion treatment at room temperature for one hour using a paint conditioner (Toyo Seiki Seisaku-sho, Ltd.).

Next, 3-acryloxypropyltrimethoxysilane (B1-1) in an amount of 10% by weight based on the weight of the particles was added, followed by dispersion treatment at room temperature for six hours. After the dispersion treatment was completed, the liquid was collected to obtain a dispersion of coated particles (A-1). The coated particles (A-1) in the dispersion had an average particle size of 20 nm.

### Production Example 2

According to the formulation shown in Table 2, a dispersion of coated particles (A-2) was produced as in Production Example 1. The coated particles (A-2) in the dispersion had an average particle size of 18 nm.

### Production Example 3

First, 85 parts by weight of PGME (G-2), 15 parts by weight of the fine particles (A0-1), and 0.75 parts by weight of a surfactant 2 (B2-2) (5% by weight based on the weight of the particles) were mixed in a 200 mL wide-mouth jar (mayonnaise jar), and zirconia beads (Nikkato Corporation, diameter 50 μm) were added thereto, followed by dispersion treatment at room temperature for one hour using a paint conditioner (Toyo Seiki Seisaku-sho, Ltd.). Next, 1.2 parts by weight (8% by weight based on the weight of the particles) of 3-acryloxypropyltrimethoxysilane (B1-1) was added, and the contents were further subjected to dispersion treatment at room temperature for four hours. After the dispersion treatment was completed, the liquid was collected to obtain a dispersion of coated particles (A-3). The coated particles (A-3) in the dispersion had an average particle size of 20 nm.

### Production Example 4

An aqueous barium hydroxide solution and an aqueous titanium tetrachloride solution were subjected to a neutralization reaction. Thereafter, the reaction product was washed with water to obtain a titanium hydroxide slurry. An aqueous barium hydroxide solution and the titanium hydroxide slurry obtained above were placed in a reaction vessel and reacted at 90° C. for three hours. Thus, a white powder of barium titanate fine particles (A0-2) was obtained. The fine particles (A0-2) had an average particle size of 20 nm. The Ba/Ti composition ratio measured using an X-ray fluorescence analyzer (Simultix12, available from Rigaku Corporation) was 0.94.

Then, 70 parts by weight of MEK (G-5) and 30 parts by weight of the fine particles (A0-2) were mixed in a 200 mL wide-mouth jar (mayonnaise jar), and zirconia beads (Nikkato Corporation, diameter 50 μm) were added thereto, followed by dispersion treatment at room temperature for one hour using a paint conditioner (Toyo Seiki Seisaku-sho, Ltd.).

Next, a surfactant 2 (B2-2) in an amount of 10% by weight based on the weight of the particles was added, followed by dispersion treatment at room temperature for six hours. After the dispersion treatment was completed, the liquid was collected to obtain a dispersion of coated particles (A-4). The coated particles (A-4) in the dispersion had an average particle size of 20 nm.

### Production Example 5

First, 70 parts by weight of PGMEA (G-4) and 30 parts by weight of the fine particles (A0-2) were mixed in a 200 mL wide-mouth jar (mayonnaise jar), and zirconia beads (Nikkato Corporation, diameter 50 μm) were added thereto, followed by dispersion treatment at room temperature for one hour using a paint conditioner (Toyo Seiki Seisaku-sho, Ltd.).

Next, a surfactant 2 (B2-2) in an amount of 20% by weight based on the weight of the particles was added, followed by dispersion treatment at room temperature for six hours. After the dispersion treatment was completed, the liquid was collected to obtain a dispersion of coated particles (A-5). The coated particles (A-5) in the dispersion had an average particle size of 20 nm.

### Production Example 6

First, 70 parts by weight of PGMEA (G-4), 30 parts by weight of the fine particles (A0-2), and 2.1 parts by weight of a surfactant 2 (B2-2) (7% by weight based on the weight of the particles) were mixed in a 200 mL wide-mouth jar (mayonnaise jar), and zirconia beads (Nikkato Corporation, diameter 50 μm) were added thereto, followed by dispersion treatment at room temperature for one hour using a paint conditioner (Toyo Seiki Seisaku-sho, Ltd.). Next, 0.9 parts by weight (3% by weight based on the weight of the particles) of 3-acryloxypropyltrimethoxysilane (B1-1) was added, and the contents were further subjected to dispersion treatment at room temperature for four hours. After the dispersion treatment was completed, the liquid was collected to obtain a dispersion of coated particles (A-6). The coated particles (A-6) in the dispersion had an average particle size of 20 nm.

### Production Example 7

According to the formulation shown in Table 2, a dispersion of comparative coated particles (A′-1) was produced as in Production Example 1. The coated particles (A′-1) in the dispersion had an average particle size of 18 nm.

### Production Example 8

A 100 mL plastic bottle was charged with 10 parts by weight of the fine particles (A0-1). Then, 90 parts by weight of toluene (G-3), 3.0 parts by weight (30% by weight based on the weight of the particles) of a surfactant 1 (B2-1), and 24 parts by weight of zirconia beads [Niimi Ceramics Co., Ltd., diameter 50 μm] were added thereto. The bottle was capped and shaken by hand for about 30 seconds for homogenization. Then, the mixture was subjected to dispersion treatment at room temperature for two hours using a paint conditioner [Red Devil, Inc.]. After the dispersion treatment was completed, the mixture was filtered through a 2300-mesh filter, and the filtrate was collected. Thus, a dispersion of comparative coated particles (A′-2) was obtained. The coated particles (A′-2) in the dispersion had an average particle size of 82 nm.

TABLE 2

| | | Production Example | | | | | | | |
|---|---|---|---|---|---|---|---|---|---|
| | | 1 | 2 | 3 | 4 | 5 | 6 | 7 | 8 |
| Coated particle | | A-1 | A-2 | A-3 | A-4 | A-5 | A-6 | A′-1 | A′-2 |
| Inorganic particle | (A0-1) | 15 | 15 | 15 | | | | 15 | 10 |
| (A0) | (A0-2) | | | | 30 | 30 | 30 | | |
| Surface treatment agent (B) | (B1-1) | 1.5 | 2.25 | 1.2 | | | 0.9 | 4.5 | |
| | (B2-1) | | | | | | | | 3.0 |
| | (B2-2) | | | 0.75 | 3.0 | 6.0 | 2.1 | | |
| Organic solvent (G) | (G-1) | 85 | 85 | | | | | 85 | |
| | (G-2) | | | 85 | | | | | |
| | (G-3) | | | | | | | | 90 |
| | (G-4) | | | | | 70 | 70 | | |
| | (G-5) | | | | 70 | | | | |

| | | | | | | | | |
|---|---|---|---|---|---|---|---|---|
| Total | 101.5 | 102.3 | 102.0 | 103.0 | 106.0 | 103.0 | 104.5 | 103.0 |
| Average particle size (nm) | 20 | 18 | 20 | 20 | 20 | 20 | 18 | 82 |
| of coated particle | | | | | | | | |
| Amount (% by weight) of surface treatment | 10 | 15 | 13 | 10 | 20 | 10 | 30 | 30 |
| agent (B) based on weight of (A0) | | | | | | | | |
| Amount (% by weight) of surface treatment | 9.1 | 13.0 | 11.5 | 9.1 | 16.7 | 9.1 | 23.1 | 23.1 |
| agent (B) based on weight of (A) | | | | | | | | |
| Amount (% by weight) of inorganic particle | 90.9 | 87.0 | 88.5 | 90.9 | 83.3 | 90.9 | 76.9 | 76.9 |
| (A0) based on weight of (A) | | | | | | | | |

The compounds shown in Table 2 are as follows.
(A0-1): Strontium titanate fine particles [Toda Kogyo Corp., particle size 18 nm]
(A0-2): Barium titanate fine particles [Toda Kogyo Corp., particle size 20 nm]
(B1-1): 3-Acryloxypropyltrimethoxysilane [silane coupling agent, KBM-5103, available from Shin-Etsu Chemical Co., Ltd., SP value: 9.1 (cal/cm³)^{1/2}]
(B2-1): Surfactant 1 [IONET 1310R, available from Sanyo Chemical Industries, Ltd.]
(B2-2): Surfactant 2 [ED-153, available from Kusumoto Chemicals, Ltd.]
(G-1): 2-Methoxyethanol [FUJIFILM Wako Pure Chemical Corporation]
(G-2): PGME [1-methoxy-2-propanol, available from Tokyo Chemical Industry Co., Ltd.]
(G-3): Toluene [methylbenzene, available from FUJIFILM Wako Pure Chemical Corporation]
(G-4): PGMEA [2-methoxy-1-methylethyl acetate, available from FUJIFILM Wako Pure Chemical Corporation]
(G-5): MEK [methyl ethyl ketone, available from FUJIFILM Wako Pure Chemical Corporation]

For each of active energy ray-curable compositions produced in the examples and comparative examples, the refractive index, total light transmittance, haze, light resistance, and transferability of a cured product of the curable composition were evaluated by the following methods.

### <Refractive Index>

The active energy ray-curable composition was dropped onto a glass substrate [Eagle XG, available from Corning Inc.], applied thereto by spin coating at a rotation speed of 3000 rpm for 30 seconds, and then dried at 80° C. for one minute. Thereafter, the composition was cured by application of ultraviolet light at 1000 mJ/cm² using an UV irradiator [VPS/1600, available from Fusion UV Systems, Inc.] in a nitrogen atmosphere. Thus, a cured product with a film thickness of 100 nm for refractive index evaluation was obtained.

The refractive index at 589 nm of the cured product prepared as described above was measured using a reflection spectroscopic thickness meter [FE-3000, available from Otsuka Electronics Co., Ltd.]. In this case, a refractive index of 1.70 or higher is preferred for the cured product.

### <Total Light Transmittance and Haze>

The active energy ray-curable composition was dropped onto a microscope glass slide [S1214, available from Matsunami Glass Ind., Ltd.], applied thereto with a bar coater, and then dried at 80° C. for three minutes. Thereafter, the composition was cured by application of ultraviolet light at 1000 mJ/cm² using an UV irradiator [VPS/1600, available from Fusion UV Systems, Inc.] in a nitrogen atmosphere. Thus, a cured product with a film thickness of about 1 μm for evaluating the total light transmittance and haze was obtained.

The total light transmittance and haze of the cured product formed on the microscope glass slide as described above were measured using a haze meter (haze-gard dual, available from BYK). In this case, for the cured product, a haze of 1.5% or lower is preferred, and a haze of 1.0% or lower is more preferred.

### <Light Resistance>

The active energy ray-curable composition was dropped onto a microscope glass slide [S1214, available from Matsunami Glass Ind., Ltd.] and applied thereto with a bar coater. Then, the composition was dried at 80° C. for three minutes, and the composition was cured by application of ultraviolet light at 2000 mJ/cm² using an UV irradiator [VPS/1600, available from Fusion UV Systems, Inc.] in a nitrogen atmosphere. Thus, a cured product with a film thickness of about 5 μm was obtained on the microscope glass slide. The cured product, together with the microscope glass slide, was placed in a light resistance tester [Eye Super UV Tester SUV-131, available from Iwasaki Electric Co., Ltd.] and application of ultraviolet light with an intensity of 25 mW/cm² for 15 hours. The obtained substrate was evaluated in terms of the difference in yellow index between before and after the test (ΔY.I.) using a spectrophotometer/colorimeter [SE7700, available from Nippon Denshoku Industries Co., Ltd.] according to the following criteria.
A: ΔY.I. is less than 10.0
B: ΔY.I. is 10.0 or more and less than 30.0
C: ΔY.I. is 30.0 or more

### <Transferability>

(1) The active energy ray-curable composition was dropped onto a glass substrate [Eagle XG, available from Corning Inc.], applied thereto using a 52 μm bar coater, and then dried at 80° C. for three minutes.
(2) The resin obtained in the step (1) was attached to a mold [DTM-2-1, available from Kyodo International, Inc.], and a roller was moved over the workpiece to push out the air. Then, the resin was cured by application of ultraviolet light at 2000 mJ/cm² through the glass substrate using an UV irradiator [VPS/1600, available from Fusion UV Systems, Inc.].
(3) The mold in the step (2) was removed, and the surface of the cured product was observed by SEM and evaluated according to the following criteria.
A: Transfer of 80% or more of the irregularities was visually observed.
B: Transfer of 50% or more to less than 80% of the irregularities was visually observed.
C: Transfer of 20% or more to less than 50% of the irregularities was visually observed.
D: Transfer of less than 20% of the irregularities was visually observed.

### Example 1

An active energy ray-curable composition was obtained by mixing homogeneously 514.7 parts by weight of the dispersion of the coated particles (A-1) obtained in Production Example 1 (83.7 parts by weight of the coated particles (A-1) and 431 parts by weight of 2-methoxyethanol (G-1)), 11.8 parts by weight of N-vinyl-2-pyrrolidone (C-8), 1.5 parts by weight of dipropylene glycol diacrylate (C-12), 1.5 parts by weight of ethoxylated bisphenol A diacrylate (C-13), 1.5 parts by weight of Omnirad TPO H (D-1) as a photopolymerization initiator, and 0.6 parts by weight of a fluorine additive (F-1) as a leveling agent.

### Example 2

An active energy ray-curable composition was obtained by mixing homogeneously 419.9 parts by weight of the dispersion of the coated particles (A-2) obtained in Production Example 2 (70.9 parts by weight of the coated particles (A-2) and 349 parts by weight of 2-methoxyethanol (G-1)), 18.9 parts by weight of o-phenoxyphenylethyl acrylate (C-3), 4.7 parts by weight of 1,4-butanediol diacrylate (C-10), 2.4 parts by weight of Omnirad TPO H (D-1) as a photopolymerization initiator, 3.1 parts by weight of a surfactant 2 (B2-2), and 1.0 parts by weight of a fluorine additive (F-1) as a leveling agent.

### Example 3

An active energy ray-curable composition was obtained by mixing homogeneously 478.8 parts by weight of the dispersion of the coated particles (A-2) obtained in Production Example 2 (80.8 parts by weight of the coated particles (A-2) and 398 parts by weight of 2-methoxyethanol (G-1)), 11.4 parts by weight of o-phenoxyphenylethyl acrylate (C-3), 2.9 parts by weight of 1,4-butanediol diacrylate (C-10), 1.4 parts by weight of Omnirad TPO H (D-1) as a photopolymerization initiator, 3.5 parts by weight of a surfactant 2 (B2-2), and 0.6 parts by weight of a fluorine additive (F-1) as a leveling agent.

### Example 4

An active energy ray-curable composition was obtained by mixing homogeneously 507.4 parts by weight of the dispersion of the coated particles (A-3) obtained in Production Example 3 (84.4 parts by weight of the coated particles (A-3) and 423 parts by weight of PGME (G-2)), 11.4 parts by weight of o-phenoxyphenylethyl acrylate (C-3), 2.8 parts by weight of 1,4-butanediol diacrylate (C-10), 1.4 parts by weight of Omnirad TPO H (D-1) as a photopolymerization initiator, and 0.6 parts by weight of a fluorine additive (F-1) as a leveling agent.

### Examples 5 to 10

According to the formulation shown in Table 3-1, the components were mixed homogeneously as in Example 2. Thus, active energy ray-curable compositions were obtained.

### Example 11

According to the formulation shown in Table 3-2, the components were mixed homogeneously as in Example 2, except that toluene (G-3) was added in an amount shown in the table. Thus, an active energy ray-curable composition was obtained.

### Example 12

According to the formulation shown in Table 3-2, the components were mixed homogeneously as in Example 2, except that PGMEA (G-4) was added in an amount shown in the table. Thus, an active energy ray-curable composition was obtained.

### Examples 13 to 21

According to the formulation shown in Table 3-2 or 3-3, the components were mixed homogeneously as in Example 2. Thus, active energy ray-curable compositions were obtained.

### Examples 22 to 25

According to the formulation shown in Table 3-3, the components were mixed homogeneously as in Example 2, except that the fluorine additive (F-1) was not added. Thus, active energy ray-curable compositions were obtained.

### Example 26

An active energy ray-curable composition was obtained by mixing homogeneously 266.4 parts by weight of the dispersion of the coated particles (A-4) obtained in Production Example 4 (85.4 parts by weight of the coated particles (A-4) and 181 parts by weight of MEK (G-5)), 11.4 parts by weight of o-phenoxyphenylethyl acrylate (C-3), 2.8 parts by weight of 1,4-butanediol diacrylate (C-10), 0.4 parts by weight of Omnirad TPO H (D-1) as a photopolymerization initiator, 0.6 parts by weight of a silicone leveling agent (F-2) as a leveling agent, and 220 parts by weight of MEK (G-5).

### Examples 27 and 28

According to the formulation shown in Table 3-3, the components were mixed homogeneously as in Example 26. Thus, active energy ray-curable compositions were obtained.

### Example 29

An active energy ray-curable composition was obtained by mixing homogeneously 251.4 parts by weight of the dispersion of the coated particles (A-5) obtained in Production Example 5 (85.4 parts by weight of the coated particles (A-5) and 166 parts by weight of PGMEA (G-4)), 11.4 parts by weight of o-phenoxyphenylethyl acrylate (C-3), 2.8 parts by weight of 1,4-butanediol diacrylate (C-10), 0.4 parts by weight of Omnirad TPO H (D-1) as a photopolymerization initiator, 0.6 parts by weight of a silicone leveling agent (F-2) as a leveling agent, and 235 parts by weight of PGMEA (G-4).

### Examples 30 to 34

According to the formulation shown in Table 3-3 or 3-4, the components were mixed homogeneously as in Example 29. Thus, active energy ray-curable compositions were obtained.

### Example 35

An active energy ray-curable composition was obtained by mixing homogeneously 266.4 parts by weight of the dispersion of the coated particles (A-6) obtained in Production Example 6 (85.4 parts by weight of the coated particles (A-6) and 181 parts by weight of PGMEA (G-4)), 11.4 parts by weight of o-phenoxyphenylethyl acrylate (C-3), 2.8 parts by weight of 1,4-butanediol diacrylate (C-10), 0.4 parts by weight of Omnirad TPO H (D-1) as a photopolymerization initiator, 0.6 parts by weight of a silicone leveling agent (F-2) as a leveling agent, and 220 parts by weight of PGMEA (G-4).

### Comparative Example 1

An active energy ray-curable composition was obtained by mixing homogeneously 255.6 parts by weight of the dispersion of the comparative coated particles (A′-1) obtained in Production Example 7 (47.6 parts by weight of the coated particles (A′-1) and 208 parts by weight of 2-methoxyethanol (G-1)), 38.1 parts by weight of phenoxydiethylene glycol acrylate (C-2), 9.5 parts by weight of 1,4-butanediol diacrylate (C-10), 4.8 parts by weight of Omnirad TPO H (D-1) as a photopolymerization initiator, and 2.0 parts by weight of a fluorine additive (F-1) as a leveling agent.

### Comparative Example 2

According to the formulation shown in Table 3-4, the components were mixed homogeneously as in Comparative Example 1. Thus, an active energy ray-curable composition was obtained.

### Comparative Example 3

An active energy ray-curable composition was obtained by mixing homogeneously 580.2 parts by weight of the dispersion of the comparative coated particles (A′-2) obtained in Production Example 8 (73.2 parts by weight of the coated particles (A′-2) and 507 parts by weight of toluene (G-3)), 19.5 parts by weight of o-phenoxyphenylethyl acrylate (C-3), 4.9 parts by weight of 1,4-butanediol diacrylate (C-10), 2.4 parts by weight of Omnirad TPO H (D-1) as a photopolymerization initiator, and 1.0 parts by weight of a fluorine additive (F-1) as a leveling agent.

### Comparative Example 4

An active energy ray-curable composition was obtained by mixing homogeneously 171.4 parts by weight of the dispersion of the comparative particles (A′-3) (85.4 parts by weight of the comparative particles (A′-3) and 86 parts by weight of PGMEA (G-4)), 11.4 parts by weight of o-phenoxyphenylethyl acrylate (C-3), 2.8 parts by weight of 1,4-butanediol diacrylate (C-10), 0.4 parts by weight of Omnirad TPO H (D-1) as a photopolymerization initiator, 0.6 parts by weight of a silicone leveling agent (F-2) as a leveling agent, and 315 parts by weight of PGMEA (G-4).

TABLE 3-1

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Formulation | Coated particle (A) | (A-1) | 83.7 | | | | 77.8 | 80.7 | 83.1 | 80.7 | 80.7 | 80.7 |
| (parts | | (A-2) | | 70.9 | 80.8 | | | | | | | |
| by | | (A-3) | | | | 84.4 | | | | | | |
| weight) | | (A-4) | | | | | | | | | | |
| | | (A-5) | | | | | | | | | | |
| | | (A-6) | | | | | | | | | | |
| | Comparative (coated) | (A′-1) | | | | | | | | | | |
| | particle (A′) | (A′-2) | | | | | | | | | | |
| | | (A′-3) | | | | | | | | | | |
| | Photopolymerizable | (C-1) | | | | | | | | | | |
| | compound (C) | (C-2) | | | | | | | | | | |
| | | (C-3) | | 18.9 | 11.4 | 11.4 | 11.0 | 11.4 | 11.7 | 11.4 | 11.4 | 11.4 |
| | | (C-4) | | | | | | | | | | |
| | | (C-5) | | | | | | | | | | |
| | | (C-6) | | | | | | | | | | |
| | | (C-7) | | | | | | | | | | |
| | | (C-8) | 11.8 | | | | | | | | | |
| | | (C-9) | | | | | | | | | | |
| | | (C-10) | | 4.7 | 2.9 | 2.8 | 2.7 | 2.8 | 2.9 | | | |
| | | (C-11) | | | | | | | | 2.8 | | |
| | | (C-12) | 1.5 | | | | | | | | 2.8 | |
| | | (C-13) | 1.5 | | | | | | | | | 2.8 |
| | | (C-14) | | | | | | | | | | |
| | | (C-15) | | | | | | | | | | |
| | | (C-16) | | | | | | | | | | |
| | Photopolymerization | (D-1) | 1.5 | 2.4 | 1.4 | 1.4 | 1.4 | 1.4 | 1.5 | 1.4 | 1.4 | 1.4 |
| | initiator (D) | (D-2) | | | | | | | | | | |
| | Surface treatment agent (B) | (B2-1) | | | | | | | | | | |
| | | (B2-2) | | 3.1 | 3.5 | | 7.1 | 3.7 | 0.8 | 3.7 | 3.7 | 3.7 |
| | | (B2-3) | | | | | | | | | | |
| | | (B2-4) | | | | | | | | | | |
| | | (B2-5 | | | | | | | | | | |
| | Leveling agent (F) | (F-1) | 0.6 | 1.0 | 0.6 | 0.6 | 0.6 | 0.6 | 0.6 | 0.6 | 0.6 | 0.6 |
| | | (F-2) | | | | | | | | | | |
| | Organic solvent (G) | (G-1) | 431 | 349 | 398 | | 401 | 416 | 428 | 416 | 416 | 416 |
| | | (G-2) | | | | 423 | | | | | | |
| | | (G-3) | | | | | | | | | | |
| | | (G-4) | | | | | | | | | | |
| | | (G-5) | | | | | | | | | | |

| | | | | | | | | | | | |
|---|---|---|---|---|---|---|---|---|---|---|---|
| | Total | 532.0 | 435.9 | 482.2 | 523.6 | 468.1 | 498.1 | 524.9 | 498.1 | 498.1 | 498.1 |
| | Total amount of (A0), (B), (C), and (D) | 100.0 | 100.0 | 100.0 | 100.0 | 100.0 | 100.0 | 100.0 | 100.0 | 100.0 | 100.0 |
| | Total amount (% by weight) | 10 | 20 | 20 | 13 | 20 | 15 | 11 | 15 | 15 | 15 |
| | of (B) based on weight of (A0) | | | | | | | | | | |
| Physical | SP value of (C) [(cal/cm³)^{1/2}] | 11.1 | 10.4 | 10.4 | 10.4 | 10.4 | 10.4 | 10.4 | 10.4 | 10.4 | 10.5 |
| properties | SP value of (B1) [(cal/cm³)^{1/2}] | 9.1 | 9.1 | 9.1 | 9.1 | 9.1 | 9.1 | 9.1 | 9.1 | 9.1 | 9.1 |
| | ΔSP value [(cal/cm³)^{1/2}] | 2.0 | 1.3 | 1.3 | 1.3 | 1.3 | 1.3 | 1.3 | 1.3 | 1.3 | 1.4 |
| | Viscosity of (C) [mPa · s] | 6 | 76 | 75 | 77 | 77 | 77 | 76 | 84 | 84 | 218 |
| Performance | Refractive index | 1.83 | 1.74 | 1.76 | 1.84 | 1.77 | 1.81 | 1.78 | 1.81 | 1.81 | 1.81 |
| evaluation | Total light transmittance (%) | 86 | 89 | 88 | 87 | 88 | 88 | 88 | 88 | 88 | 88 |
| | Haze (%) | 1.0 | 0.5 | 0.5 | 0.2 | 0.3 | 0.2 | 0.5 | 0.3 | 0.3 | 0.3 |
| | Light resistance | A | A | A | A | A | A | A | A | A | A |
| | Transferability | A | A | A | A | A | A | A | A | A | A |

TABLE 3-2

| | | | Example | | | | | | | | | |
|---|---|---|---|---|---|---|---|---|---|---|---|---|
| | | | 11 | 12 | 13 | 14 | 15 | 16 | 17 | 18 | 19 | 20 |
| Formulation | Coated particle (A) | (A-1) | 80.7 | 80.7 | 80.7 | 90.9 | 90.9 | 90.9 | 80.7 | 90.9 | 90.9 | 90.9 |
| (parts | | (A-2) | | | | | | | | | | |
| by | | (A-3) | | | | | | | | | | |
| weight) | | (A-4) | | | | | | | | | | |
| | | (A-5) | | | | | | | | | | |
| | | (A-6) | | | | | | | | | | |
| | Comparative (coated) | (A′-1) | | | | | | | | | | |
| | particle (A′) | (A′-2) | | | | | | | | | | |
| | | (A′-3) | | | | | | | | | | |
| | Photopolymerizable | (C-1) | | | | 0.6 | | | | | | |
| | compound (C) | (C-2) | | | | | 0.6 | | | | | |
| | | (C-3) | 11.4 | 11.4 | 11.4 | | | | | | | |
| | | (C-4) | | | | | | 0.6 | | | | |
| | | (C-5) | | | | | | | 11.4 | | | |
| | | (C-6) | | | | | | | | 0.6 | | |
| | | (C-7) | | | | | | | | | 0.6 | |
| | | (C-8) | | | | | | | | | | 0.6 |
| | | (C-9) | | | | | | | | | | |
| | | (C-10) | | | | 1.5 | 1.5 | 1.5 | 1.5 | 1.5 | 1.5 | 1.0 |
| | | (C-11) | | | | | | | | | | |
| | | (C-12) | | | | | | | | | | |
| | | (C-13) | | | | 1.5 | 1.5 | 1.5 | 1.5 | 1.5 | 1.5 | 2.0 |
| | | (C-14) | 2.8 | | | | | | | | | |
| | | (C-15) | | 2.8 | | | | | | | | |
| | | C-16) | | | 2.8 | | | | | | | |
| | Photopolymerization | (D-1) | 1.4 | 1.4 | 1.4 | 1.4 | 1.4 | 1.4 | 1.4 | 1.4 | 1.4 | 1.4 |
| | initiator (D) | (D-2) | | | | | | | | | | |
| | Surface treatment agent (B) | (B2-1) | | | | | | | | | | |
| | | (B2-2) | 3.7 | 3.7 | 3.7 | 4.1 | 4.1 | 4.1 | 3.7 | 4.1 | 4.1 | 4.1 |
| | | (B2-3) | | | | | | | | | | |
| | | (B2-4) | | | | | | | | | | |
| | | B2-5 | | | | | | | | | | |
| | Leveling agent (F) | (F-1) | 0.6 | 0.6 | 0.6 | 0.6 | 0.6 | 0.6 | 0.6 | 0.6 | 0.6 | 0.6 |
| | | (F-2 | | | | | | | | | | |
| | Organic solvent (G) | (G-1) | 416 | 416 | 416 | 468 | 468 | 468 | 416 | 468 | 468 | 468 |
| | | (G-2) | | | | | | | | | | |
| | | (G-3) | 100 | | | | | | | | | |
| | | (G-4) | | 100 | | | | | | | | |
| | | (G-5) | | | | | | | | | | |

| | | | | | | | | | | | |
|---|---|---|---|---|---|---|---|---|---|---|---|
| | Total | 598.1 | 598.1 | 498.1 | 548.5 | 548.5 | 548.5 | 498.1 | 548.5 | 548.5 | 548.5 |
| | Total amount of (A0), (B), (C), and (D) | 100.0 | 100.0 | 100.0 | 100.0 | 100.0 | 100.0 | 100.2 | 100.0 | 100.0 | 100.0 |
| | Total amount (% by weight) | 15 | 15 | 15 | 15 | 15 | 15 | 15 | 15 | 15 | 15 |
| | of (B) based on weight of (A0) | | | | | | | | | | |
| Physical | SP value of (C) [(cal/cm³)^{1/2}] | 10.4 | 10.3 | 10.6 | 10.0 | 10.0 | 10.1 | 10.1 | 10.1 | 10.2 | 10.3 |
| properties | SP value of (B1) [(cal/cm³)^{1/2}] | 9.1 | 9.1 | 9.1 | 9.1 | 9.1 | 9.1 | 9.1 | 9.1 | 9.1 | 9.1 |
| | ΔSP value [(cal/cm³)^{1/2}] | 1.3 | 1.2 | 1.5 | 0.9 | 0.9 | 1.0 | 1.0 | 1.0 | 1.1 | 1.2 |
| | Viscosity of (C) [mPa · s] | 203 | 128 | 320 | 49 | 51 | 56 | 5 | 123 | 53 | 87 |
| Performance | Refractive index | 1.81 | 1.81 | 1.81 | 1.91 | 1.90 | 1.91 | 1.91 | 1.91 | 1.90 | 1.90 |
| evaluation | Total light transmittance (%) | 88 | 88 | 88 | 86 | 86 | 86 | 86 | 86 | 86 | 86 |
| | Haze (%) | 0.3 | 0.3 | 0.3 | 0.2 | 0.2 | 0.2 | 0.2 | 0.2 | 0.2 | 0.2 |
| | Light resistance | A | A | A | A | A | A | A | A | A | A |
| | Transferability | A | A | A | A | A | A | A | A | A | A |

TABLE 3-3

| | | | Example | | | | | | | | | |
|---|---|---|---|---|---|---|---|---|---|---|---|---|
| | | | 21 | 22 | 23 | 24 | 25 | 26 | 27 | 28 | 29 | 30 |
| Formu- | Coated particle (A) | (A-1) | 90.9 | 80.7 | 80.7 | 80.7 | 80.7 | | | | | |
| lation | | (A-2) | | | | | | | | | | |
| (parts | | (A-3) | | | | | | | | | | |
| by | | (A-4) | | | | | | 85.4 | 85.4 | 85.4 | | |
| weight) | | (A-5) | | | | | | | | | 85.4 | 85.4 |
| | | (A-6) | | | | | | | | | | |
| | Comparative (coated) | (A′-1) | | | | | | | | | | |
| | particle (A′) | (A′-2) | | | | | | | | | | |
| | | (A′-3) | | | | | | | | | | |
| | Photopolymerizable | (C-1) | | | | | | | | | | |
| | compound (C) | (C-2) | | | | | | | | | | |
| | | (C-3) | | 11.4 | 11.4 | 11.4 | 11.4 | 11.4 | 11.4 | 7.1 | 11.4 | 11.4 |
| | | (C-4) | | | | | | | | | | |
| | | (C-5) | | | | | | | | | | |
| | | (C-6) | | | | | | | | | | |
| | | (C-7) | | | | | | | | | | |
| | | (C-8) | | | | | | | | | | |
| | | (C-9) | 0.6 | | | | | | | | | |
| | | (C-10) | 1.5 | 2.8 | 2.8 | 2.8 | 2.8 | 2.8 | | | 2.8 | |
| | | (C-11) | | | | | | | | | | |
| | | (C-12) | | | | | | | | | | |
| | | (C-13) | 1.5 | | | | | | 2.8 | 7.1 | | 2.8 |
| | | (C-14) | | | | | | | | | | |
| | | (C-15) | | | | | | | | | | |
| | | (C-16) | | | | | | | | | | |
| | Photopolymerization | (D-1) | 1.4 | | | | | 0.4 | 0.4 | 0.4 | 0.4 | 0.4 |
| | initiator (D) | (D-2) | | 1.4 | 1.4 | 1.4 | 1.4 | | | | | |
| | Surface treatment | (B2-1) | | 3.7 | | | | | | | | |
| | agent (B) | (B2-2) | 4.1 | | | | | | | | | |
| | | (B2-3) | | | 3.7 | | | | | | | |
| | | (B2-4) | | | | 3.7 | | | | | | |
| | | (B2-5) | | | | | 3.7 | | | | | |
| | Leveling agent (F) | (F-1) | 0.6 | | | | | | | | | |
| | | (F-2) | | | | | | 0.6 | 0.6 | 0.6 | 0.6 | 0.6 |
| | Organic solvent (G) | (G-1) | 468 | 416 | 416 | 416 | 416 | | | | | |
| | | (G-2) | | | | | | | | | | |
| | | (G-3) | | | | | | | | | | |
| | | (G-4) | | | | | | | | | 401 | 401 |
| | | (G-5) | | | | | | 401 | 401 | 401 | | |

| | | | | | | | | | | | |
|---|---|---|---|---|---|---|---|---|---|---|---|
| | Total | 548.5 | 497.5 | 497.5 | 497.7 | 497.5 | 501.6 | 501.6 | 501.6 | 501.6 | 501.6 |
| | Total amount of | 100.0 | 100.0 | 100.0 | 100.0 | 100.0 | 100.0 | 100.0 | 100.0 | 100.0 | 100.0 |
| | (A0), (B), (C), and (D) | | | | | | | | | | |
| | Total amount (% by | 15 | 15 | 15 | 15 | 15 | 10 | 10 | 10 | 20 | 20 |
| | weight) of (B) based | | | | | | | | | | |
| | on weight of (A0) | | | | | | | | | | |
| Physical | SP value of (C) | 10.7 | 10.4 | 10.4 | 10.4 | 10.4 | 10.4 | 10.5 | 10.4 | 10.4 | 10.5 |
| properties | [(cal/cm³)^{1/2}] | | | | | | | | | | |
| | SP value of (B1) | 9.1 | 9.1 | 9.1 | 9.1 | 9.1 | — | — | — | — | — |
| | [(cal/cm³)^{1/2}] | | | | | | | | | | |
| | ΔSP value [(cal/cm³)^{1/2}] | 1.6 | 1.3 | 1.3 | 1.3 | 1.3 | — | — | — | — | — |
| | Viscosity of (C) [mPa · s] | 89 | 77 | 77 | 77 | 77 | 77 | 218 | 387 | 77 | 218 |
| Perfor- | Refractive index | 1.91 | 1.81 | 1.81 | 1.81 | 1.81 | 1.85 | 1.86 | 1.85 | 1.77 | 1.78 |
| mance | Total light transmittance (%) | 86 | 88 | 88 | 88 | 88 | 87 | 87 | 87 | 89 | 89 |
| eval- | Haze (%) | 0.2 | 0.3 | 0.5 | 0.5 | 0.2 | 0.3 | 0.3 | 0.3 | 0.2 | 0.2 |
| uation | Light resistance | A | A | A | A | A | A | A | A | A | A |
| | Transferability | A | B | B | B | B | A | A | A | A | A |

TABLE 3-4

| | | | Example | | | | | Comparative Example | | | |
|---|---|---|---|---|---|---|---|---|---|---|---|
| | | | 31 | 32 | 33 | 34 | 35 | 1 | 2 | 3 | 4 |
| Formu- | Coated particle (A) | (A-1) | | | | | | | | | |
| lation | | (A-2) | | | | | | | | | |
| (parts | | (A-3) | | | | | | | | | |
| by | | (A-4) | | | | | | | | | |
| weight) | | (A-5) | 85.4 | 85.4 | 85.4 | 85.4 | | | | | |
| | | (A-6) | | | | | 85.4 | | | | |
| | Comparative | (A′-1) | | | | | | 47.6 | 83.7 | | |
| | (coated) | (A′-2) | | | | | | | | 73.2 | |
| | particle (A′) | (A′-3) | | | | | | | | | 85.4 |
| | Photopolymerizable | (C-1) | | | | | | | | | |
| | compound (C) | (C-2) | | | | | | 38.1 | | | |
| | | (C-3) | 7.1 | | | | 11.4 | | 11.8 | 19.5 | 11.4 |
| | | (C-4) | | | | | | | | | |
| | | (C-5) | | | | | | | | | |
| | | (C-6) | | 12.0 | 13.0 | 14.2 | | | | | |
| | | (C-7) | | | | | | | | | |
| | | (C-8) | | | | | | | | | |
| | | (C-9) | | | | | | | | | |
| | | (C-10) | | 2.2 | 1.2 | | 2.8 | 9.5 | 3.0 | 4.9 | 2.8 |
| | | (C-11) | | | | | | | | | |
| | | (C-12) | | | | | | | | | |
| | | (C-13) | 7.1 | | | | | | | | |
| | | (C-14) | | | | | | | | | |
| | | (C-15) | | | | | | | | | |
| | | (C-16) | | | | | | | | | |
| | Photo- | (D-1) | 0.4 | 0.4 | 0.4 | 0.4 | 0.4 | 4.8 | 1.5 | 2.4 | 0.4 |
| | polymerization | (D-2) | | | | | | | | | |
| | initiator (D) | | | | | | | | | | |
| | Surface treatment | (B2-1) | | | | | | | | | |
| | agent (B) | (B2-2) | | | | | | | | | |
| | | (B2-3) | | | | | | | | | |
| | | (B2-4) | | | | | | | | | |
| | | (B2-5) | | | | | | | | | |
| | Leveling agent (F) | (F-1) | | | | | | 2.0 | 0.6 | 1.0 | |
| | | (F-2) | 0.6 | 0.6 | 0.6 | 0.6 | 0.6 | | | | 0.6 |
| | Organic solvent (G) | (G-1) | | | | | | 208 | 365 | | |
| | | (G-2) | | | | | | | | | |
| | | (G-3) | | | | | | | | 507 | |
| | | (G-4) | 401 | 401 | 401 | 401 | 401 | | | | 401 |
| | | (G-5) | | | | | | | | | |

| | | | | | | | | | | |
|---|---|---|---|---|---|---|---|---|---|---|
| | Total | 501.6 | 501.6 | 501.6 | 501.6 | 501.6 | 310.0 | 465.6 | 608.0 | 501.6 |
| | Total amount of | 100.0 | 100.0 | 100.0 | 100.0 | 100.0 | 100.0 | 100.0 | 100.0 | 100.0 |
| | (A0), (B), (C), and (D) | | | | | | | | | |
| | Total amount (% by | 20 | 20 | 20 | 20 | 10 | 30 | 30 | 30 | — |
| | weight) of (B) based | | | | | | | | | |
| | on weight of (A0) | | | | | | | | | |
| Physical | SP value of (C) | 10.4 | 10.5 | 10.5 | 10.6 | 10.4 | 10.0 | 10.4 | 10.4 | 10.4 |
| properties | [(cal/cm³)^{1/2}] | | | | | | | | | |
| | SP value of (B1) | — | — | — | — | 9.1 | 9.1 | 9.1 | — | — |
| | [(cal/cm³)^{1/2}] | | | | | | | | | |
| | ΔSP value [(cal/cm³)^{1/2}] | — | — | — | — | 1.3 | 0.9 | 1.3 | — | — |
| | Viscosity of (C) [mPa · s] | 387 | 790 | 1205 | 2000 | 77 | 9 | 75 | 76 | 77 |
| Perfor- | Refractive index | 1.77 | 1.78 | 1.78 | 1.78 | 1.85 | 1.59 | 1.69 | 1.67 | 1.83 |
| mance | Total light transmittance (%) | 89 | 89 | 89 | 89 | 87 | 88 | 87 | 75 | 87 |
| eval- | Haze (%) | 0.2 | 0.2 | 0.2 | 0.2 | 0.2 | 1.4 | 1.1 | 10.0 | 0.3 |
| uation | Light resistance | A | A | A | A | A | A | A | A | C |
| | Transferability | A | B | B | C | A | A | A | D | A |

Of the compounds shown in Tables 3-1 to 3-4, those not shown in Table 2 are as follows (the unit of SP value is (cal/cm³)^{1/2}, and the unit of viscosity is (mPs·s)).
(A′-3): A dispersion in which surface-treated titanium oxide particles are dispersed in PGMEA [LTPF, available from Pixcelligent, solid concentration: 50% by weight, average particle size of titanium oxide particles: 20 nm]
(B2-3): Surfactant 3 [TEGO® Dispers 690, available from Evonik]
(B2-4): Surfactant 4 [Emanon 1112, available from Kao Corporation]
(B2-5): Surfactant 5 [BEAULIGHT LCA-H, available from Sanyo Chemical Industries, Ltd.]
(C-1): Phenoxyethyl acrylate [PO-A, available from Kyoeisha Chemical Co., Ltd., SP value: 10.1, refractive index (25° C.): 1.52, viscosity (25° C.): 8.3]
(C-2): Phenoxydiethylene glycol acrylate [P2H-A, available from Kyoeisha Chemical Co., Ltd., SP value: 10.1, refractive index (25° C.): 1.51, viscosity (25° C.): 10.0]
(C-3): o-Phenoxyphenylethyl acrylate [A-LEN-10, available from Shin-Nakamura Chemical Co., Ltd., SP value: 10.6, refractive index (25° C.): 1.58, viscosity (25° C.): 150.0]
(C-4): m-Phenoxybenzyl acrylate [POB-A, available from Kyoeisha Chemical Co., Ltd., SP value: 10.8, refractive index (25° C.): 1.57, viscosity (25° C.): 18.0]
(C-5): Benzyl acrylate [Viscoat #160, available from Osaka Organic Chemical Industry Ltd., SP value: 10.1, refractive index (25° C.): 1.51, viscosity (25° C.): 2.2]
(C-6): Blended mixture of acrylic modified bisphenoxyethanol fluorene and o-phenoxyphenyl ethyl acrylate (40:60) [Etermer EM2206, available from Eternal Materials, difunctional, SP value: 10.6, refractive index (25° C.): 1.59, viscosity (25° C.): 2000.0]
(C-7): N-acryloylmorpholine [ACMO, available from KJ Chemicals Corporation, SP value: 11.2, refractive index (25° C.): 1.51, viscosity (25° C.): 12.0]
(C-8): N-vinyl-2-pyrrolidone [NVP, available from BASF Japan Ltd., SP value: 11.4, refractive index (25° C.): 1.50, viscosity (25° C.): 3.0]
(C-9): Hydroxyethylacrylamide [HEAA, available from KJ Chemicals Corporation, SP value: 14.4, refractive index (25° C.): 1.52, viscosity (25° C.): 280.0]
(C-10): 1,4-Butanediol diacrylate [Viscoat #195, available from Osaka Organic Chemical Industry Ltd., difunctional, SP value: 9.7, refractive index (25° C.): 1.46, viscosity (25° C.): 5.0]
(C-11): 1,9-Nonanediol diacrylate [A-NOD-N, available from Shin-Nakamura Chemical Co., Ltd., difunctional, SP value: 9.4, refractive index (25° C.): 1.46, viscosity (25° C.): 8.0]
(C-12): Dipropylene glycol diacrylate [Miramer M222, available from Miwon, difunctional, SP value: 9.5, refractive index (25° C.): 1.45, viscosity (25° C.): 8.0]
(C-13): Ethoxylated bisphenol A diacrylate [Neomer BA-641, available from Sanyo Chemical Industries, Ltd., difunctional, SP value: 10.2, refractive index (25° C.): 1.54, viscosity (25° C.): 1000.0]
(C-14): Ethoxylated bisphenol A diacrylate (adduct with 20 mol EO) [A-BPE-20, Shin-Nakamura Chemical Co., Ltd., difunctional, SP value: 9.7, refractive index (25° C.): 1.50, viscosity (25° C.): 700.0]
(C-15): Polypropylene glycol diacrylate [APG-700: Sanyo Chemical Industries, Ltd., tetrafunctional, SP value: 8.9, refractive index (25° C.): 1.45, viscosity (25° C.): 68.0]
(C-16): Dipentaerythritol hexaacrylate [Neomer DA-600, available from Sanyo Chemical Industries, Ltd., hexafunctional, SP value: 10.8, refractive index (25° C.): 1.47, viscosity (25° C.): 7000.0]
(D-1): Omnirad TPO H [2,4,6-trimethylbenzoyldiphenylphosphine oxide, available from IGM Resins B. V.]
(D-2): Omnirad 184 [1-hydroxycyclohexyl phenyl ketone, available from IGM Resins B.V.]
(F-1): Fluorine additive [F-444, available from DIC Corporation]
(F-2): Silicone leveling agent [BYK-333, available from BYK Japan KK]

The results in Tables 3-1 to 3-4 demonstrate that the cured product of Comparative Example 4 using surface-treated titanium oxide particles has poor light resistance. The results also demonstrate that the cured product of Comparative Example 3 using coated particles containing a large amount of a surface treatment agent and having a large particle size has a low refractive index, poor transparency, and poor transferability. The results also demonstrate that the cured products of Comparative Examples 1 and 2 using coated particles containing a large amount of a surface treatment agent each have a low refractive index. On the other hand, the cured products obtained in the respective examples are excellent in transparency, light resistance, and transferability and have a high refractive index.

### INDUSTRIAL APPLICABILITY

The cured product of the active energy ray-curable composition of the present invention has a high refractive index and is excellent in transparency, light resistance, and transferability, and is thus useful as an optical member. Specifically, the cured product of the active energy ray-curable composition of the present invention is useful as an optical component such as a plastic lens (e.g., a prism lens, a lenticular lens, a microlens, a Fresnel lens, or a viewing angle increasing lens), an optical compensation film, a retardation film, a prism, an optical fiber, a solder resist for flexible printed wiring, a plating resist, an interlayer insulating film for multilayer printed wiring boards, and a photosensitive optical waveguide.

1. An active energy ray-curable composition, comprising:
a coated particle (A);
a photopolymerizable compound (C); and
a photopolymerization initiator (D),
the coated particle (A) including:
an inorganic particle (A0) containing a titanate compound represented by MTiO₃, where M is at least one of Ba or Sr; and
a surface treatment agent (B) coating at least a portion of a surface of the inorganic particle (A0),
the coated particle (A) having an average particle size of 10 nm to 40 nm,
the surface treatment agent (B) being contained in the coated particle (A) in an amount of 5% by weight to 20% by weight based on a weight of the inorganic particle (A0).

2. The active energy ray-curable composition according to claim 1,
wherein the surface treatment agent (B) is at least one of a coupling agent (B1) or a surfactant (B2), the coupling agent (B1) is at least one selected from the group consisting of a silane coupling agent, a titanate coupling agent, and an aluminate coupling agent, and the surfactant (B2) is a surfactant having a hydroxy group, an ester group, a phosphate group, a carboxy group, or an amino group.

3. The active energy ray-curable composition according to claim 2,
wherein the coupling agent (B1) has a solubility parameter of 7.0 (cal/cm³)^{1/2} to 9.3 (cal/cm³)^{1/2}.

4. The active energy ray-curable composition according to claim 2,
wherein an absolute value of a difference between a solubility parameter of the photopolymerizable compound (C) and the solubility parameter of the coupling agent (B1) (ΔSP value) is 0.5 (cal/cm³)^{1/2} to 4.0 (cal/cm³)^{1/2}.

5. The active energy ray-curable composition according to claim 1,
wherein the photopolymerizable compound (C) has a refractive index of 1.50 or higher.

6. The active energy ray-curable composition according to claim 1,
wherein the photopolymerizable compound (C) has a viscosity at 25° C. of 1300 mPa·s or less.

7. A cured product of the active energy ray-curable composition according to claim 1.
